(19) United States
(12) Patent Application Publication
(10) Pub. No.: US 2026/0089200 A1
(43) Pub. Date: Mar. 26, 2026

(54) COMMUNICATING DATA BURST TRAFFIC CHARACTERISTICS IN AN RTP HEADER EXTENSION FOR AN RTP MEDIA COMMUNICATION SESSION

(71) Applicant: QUALCOMM Incorporated, San Diego, CA (US)

(72) Inventors: Liangping Ma, San Diego, CA (US); Imed Bouazizi, Celina, TX (US)

(21) Appl. No.: 19/330,308

(22) Filed: Sep. 16, 2025

Related U.S. Application Data
(60) Provisional application No. 63/697,108, filed on Sep. 20, 2024.
(60) Provisional application No. 63/771,986, filed on Mar. 14, 2025.

(51) Int. Cl. H04L 65/70; H04L 65/1069; H04L 65/65

(52) U.S. Cl. CPC H04L 65/70; H04L 65/1069; H04L 65/65

(57) ABSTRACT

An example device for communicating data via a network includes a memory configured to store data, and a processing system implemented in circuitry and configured to: send or receive a first protocol data unit (PDU) of a data burst, the first PDU including data representing a predicted burst size (BSSize) value for the data burst; and send or receive a second PDU of the data burst after having sent or received the first PDU, the second PDU including data for updating the predicted BSSize value for the data burst to an actual BSSize value for the data burst. A sending device may send the data for updating the predicted BSSize value when the sending device sends the first PDU before all PDUs of the data burst have been formed. A receiving device may use the actual BSSize value to, e.g., perform resource allocation.

This application claims the benefit of U.S. Provisional Application No. 63/697,108, filed Sep. 20, 2024, and of U.S. Provisional Application No. 63/771,986, filed Mar. 14, 2025, the entire contents of each of which are hereby incorporated by reference.

### TECHNICAL FIELD

This disclosure relates to transport of data, such as media data, via a network.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), ITU-T H.265 (also referred to as High Efficiency Video Coding (HEVC)), and extensions of such standards, to transmit and receive digital video information more efficiently.

Video compression techniques perform spatial prediction and/or temporal prediction to reduce or remove redundancy inherent in video sequences. For block-based video coding, a video frame or slice may be partitioned into macroblocks. Each macroblock can be further partitioned. Macroblocks in an intra-coded (I) frame or slice are encoded using spatial prediction with respect to neighboring macroblocks. Macroblocks in an inter-coded (P or B) frame or slice may use spatial prediction with respect to neighboring macroblocks in the same frame or slice or temporal prediction with respect to other reference frames.

After video data has been encoded, the video data may be packetized for transmission or storage. The video data may be assembled into a video file conforming to any of a variety of standards, such as the International Organization for Standardization (ISO) base media file format and extensions thereof, such as AVC.

### SUMMARY

In general, this disclosure describes techniques related to signaling data burst traffic characteristics for communicating data via a network. In general, a data burst may include multiple protocol data units (PDUs) that are sent in a short period of time. A sending device may determine the meaning of “a short period of time” for a data burst, e.g., based on an implementation of the sending device and/or data transmission. The data burst traffic characteristics may indicate a time between data bursts and/or a predicted size of a next data burst. Per techniques of this disclosure, the data burst traffic characteristics may be signaled in, e.g., an RTP header extension.

A sending device may signal a burst size value (e.g., “BSSize”) for a data burst. The sending device may predict this burst size value for the data burst before all data of the data burst has been formed, e.g., before all PDUs of the data burst have been formed. In some cases, the actual data burst size may differ from the predicted burst size value. Therefore, the sending device may send data indicating how the predicted burst size value is to be modified to determine the actual burst size value for the data burst. The data indicating how the predicted burst size value is to be modified may be sent in a subsequent PDU of the data burst, e.g., any later PDU up to or including an ordinal last PDU of the data burst. A receiving device may use the burst size value to perform resource allocation and/or to determine when receiving circuitry is to be disabled for a period of time. For example, a base station (e.g., a gNodeB or gNB) may allocate resources for receiving PDUs of the data burst using the BSSize value. Additionally or alternatively, a user equipment (UE) device may disable receive circuitry after all data of the current data burst has been received, e.g., until a time to next burst (TTNB) indicated for a subsequent data burst. In this manner, the base station and/or the UE may conserve resources, such as battery power, associated with receiving data of a communication session using the burst size value and an updated burst size value per techniques of this disclosure.

In one example, a method of communicating data via a network includes: receiving a first protocol data unit (PDU) of a data burst, the first PDU including data representing a predicted burst size (BSSize) value for the data burst; receiving a second PDU of the data burst after having received the first PDU, the second PDU including data for updating the predicted BSSize value for the data burst to an actual BSSize value for the data burst; updating the predicted BSSize value to the actual BSSize value based on the data of the second PDU; and using the actual BSSize value to receive one or more subsequent PDUs of the data burst.

In another example, a device for communicating data via a network includes: a memory configured to store data; and a processing system implemented in circuitry and configured to: receive a first protocol data unit (PDU) of a data burst, the first PDU including data representing a predicted burst size (BSSize) value for the data burst; receive a second PDU after having received the first PDU, the second PDU including data for updating the predicted BSSize value for the data burst to an actual BSSize value for the data burst; update the predicted BSSize value to the actual BSSize value based on the data of the second PDU; and use the actual BSSize value to receive one or more subsequent PDUs of the data burst.

In another example, a method of communicating data via a network includes: predicting a predicted burst size (BSSize) for a data burst, the data burst including a plurality of protocol data units (PDUs); sending a first PDU of the data burst, the first PDU including data representing the predicted BSSize for the data burst, wherein sending the first PDU comprises sending the first PDU before an ordinal last PDU of the plurality of PDUs has been formed; after forming one or more additional PDUs of the plurality of PDUs, determining an actual BSSize value for the data burst; and sending a second PDU of the data burst, the second PDU including data for updating the predicted BSSize value for the data burst to the actual BSSize value for the data burst.

In another example, a device for communicating data via a network, the device comprising: a memory configured to store data; and a processing system implemented in circuitry and configured to: predict a predicted burst size (BSSize) for a data burst, the data burst including a plurality of protocol data units (PDUs); send a first PDU of the data burst, the first PDU including data representing the predicted BSSize for the data burst, wherein sending the first PDU comprises sending the first PDU before an ordinal last PDU of the plurality of PDUs has been formed; after forming one or more additional PDUs of the plurality of PDUs, determine an actual BSSize value for the data burst; and send a second PDU of the data burst, the second PDU including data for updating the predicted BSSize value for the data burst to the actual BSSize value for the data burst.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system that implements techniques for streaming media data over a network.

FIG. 2 is a block diagram illustrating elements of an example video file.

FIG. 3 is a conceptual diagram illustrating an example one-byte format for an RTP header extension for PDU set marking per techniques of this disclosure.

FIG. 4 is a conceptual diagram illustrating an example two-byte format for an RTP header extension for PDU set marking per techniques of this disclosure.

FIG. 5 is a conceptual diagram illustrating an example one-byte format for an RTP header extension for data burst traffic characteristics per techniques of this disclosure.

FIG. 6 is a conceptual diagram illustrating an example two-byte format for an RTP header extension for data burst traffic characteristics per techniques of this disclosure.

FIG. 7 is a conceptual diagram illustrating example data bursts and protocol data units (PDUs) thereof.

FIG. 8 is a conceptual diagram illustrating an example Real-time Transport Protocol (RTP) header extension that may be used to signal data burst traffic characteristics per techniques of this disclosure.

FIG. 9 is a conceptual diagram illustrating an example sequence of PDUs sent as part of a data burst.

FIG. 10 is a block diagram illustrating an example set of network devices that may perform various aspects of the techniques of this disclosure.

FIG. 11 is a flowchart illustrating an example method for sending data of a communication session per techniques of this disclosure.

FIG. 12 is a flowchart illustrating an example method for receiving data of a communication session per techniques of this disclosure.

### DETAILED DESCRIPTION

In general, this disclosure describes techniques related to communicating data representative of data burst traffic characteristics. These techniques may be used in combination with a transmission protocol, such as Real-time Transport Protocol (RTP) or QUIC. Per these techniques, the data burst traffic characteristics may be signaled in an RTP header extension or a QUIC header extension of a packet. In particular, these techniques may be used to signal protocol data unit (PDU) characteristics, where a PDU may correspond to a particular set of media data. A PDU Set may include each PDU of a variety of different types of media data that are to be presented at substantially the same playback time, e.g., one or more frames of video and/or audio data.

Traffic characteristics of a data burst may be communicated in network metadata. A data burst may represent a set of multiple PDUs generated and sent in a short period of time, e.g., per TS 23.501 clause 3.1. A sending device may determine the meaning of “a short period of time” for a data burst, e.g., based on an implementation of the sending device and/or data transmission. The characteristics may include a time gap between two adjacent data bursts and the size of each data burst. The characteristics may remain to some extent, even after the data bursts traverse a communication network. The traffic characteristic indication may help a radio access network (RAN) base station to schedule transmissions and/or to perform discontinuous reception (DRX) adaptation.

RTP header extensions may be used to communicate the data burst traffic characteristics, per the techniques of this disclosure. An existing RTP header extension for PDU Set marking may be enhanced, or a new RTP header extension may be dedicated to data burst traffic characteristics. Alternatively, other protocol headers may convey the data burst traffic characteristics, such as a QUIC header extension.

One data burst traffic characteristic is the time to the next data burst (TNDB). The starting time of TNDB may be the last packet of the current data burst or the first packet of the current data burst. Being the last packet of the current data burst may make the TNDB value more accurate, especially when the packets in a data burst are sent in a paced way (e.g., uniform inter-packet departure times), but this leaves the base station less reaction time. Being the first packet of the current data burst may lead to higher TNDB prediction error, but gives the base station more reaction time. There are times where flexibility in the definition of the starting time for TNDB may be beneficial, and to indicate the accuracy of the prediction of the TNDB value.

Another data burst traffic characteristic is the next data burst size. The value representing the next data burst size may need to be predicted. Such prediction can be difficult, but the prediction may be useful to the base station for resource allocation. Thus, it may be beneficial to provide an indication of an expected prediction error for the next data burst size.

Per techniques of this disclosure, a predicted data burst size for a current data burst may be updated while the current data burst is being transmitted. For example, a sending device (e.g., a server device) may predict the data burst size for a current data burst before all PDUs of the current data burst have been formed. The sending device may signal the predicted data burst size in data of an ordinal first PDU of the data burst. The prediction may be inaccurate or additional/less data may be transmitted as part of the data burst. Therefore, per techniques of this disclosure, the sending device may send data indicating how to modify the predicted data burst size (BSSize) to form an actual data burst size for the current data burst. For example, the sending device may send data indicating an offset to be applied to the predicted data burst size, such that the offset is to be added to or subtracted from the predicted data burst size value. As another example, the sending device may send the full size of the current data burst, which is to replace the predicted data burst size.

A receiving device, such as a base station (e.g., a gNodeB (gNB)) or a client device (e.g., a user equipment (UE)) may use the burst size to perform resource allocation and/or to schedule disabling of reception circuitry once all data of the current data burst has been received, for a period of time until a next scheduled data burst (e.g., a TTNB value). For example, a UE may be configured to determine an actual BSSize value for a current data burst and that a next data burst will begin at a time indicated by a TTNB value. Therefore, after having received an amount of data of the current data burst equal to the actual BSSize value, the UE may disable reception circuitry for a period of time from an end of the current burst until a time indicated by the TTNB value. In this manner, the UE may save battery power while also avoiding loss of data of a communication session. Similarly, a base station may allocate resources accurately for reception of the current data burst, which may avoid loss of data of a communication session. Moreover, a sending device may update characteristics of the current data burst, which may allow the sending device to send data faster, thereby reducing latency of transmission, rather than waiting until a subsequent data burst to send the additional data.

As various examples, a base station may use the prediction of the burst size and time to next burst information to select a resource allocation type, perform a frequency domain resource assignment and/or a time domain resource assignment, determine a modulation and coding scheme, or the like. Additionally or alternatively, the base station may allocate slots and/or symbols within slots to a UE involved in a communication session based on the time to next burst and burst size information. Additionally or alternatively, the base station may allocate resource blocks and/or resource block groups to the UE, configure subcarrier spacing, and/or configure bandwidth parts (BWPs) for the UE based on the time to next burst and burst size information for a current burst of the communication session that the UE is engaged in. Moreover, the base station may update resource allocation configuration based on the updated (actual) burst size value for a current data burst.

The techniques of this disclosure may be applied to video files conforming to video data encapsulated according to any of ISO base media file format, Scalable Video Coding (SVC) file format, Advanced Video Coding (AVC) file format, Third Generation Partnership Project (3GPP) file format, and/or Multiview Video Coding (MVC) file format, or other similar video file formats.

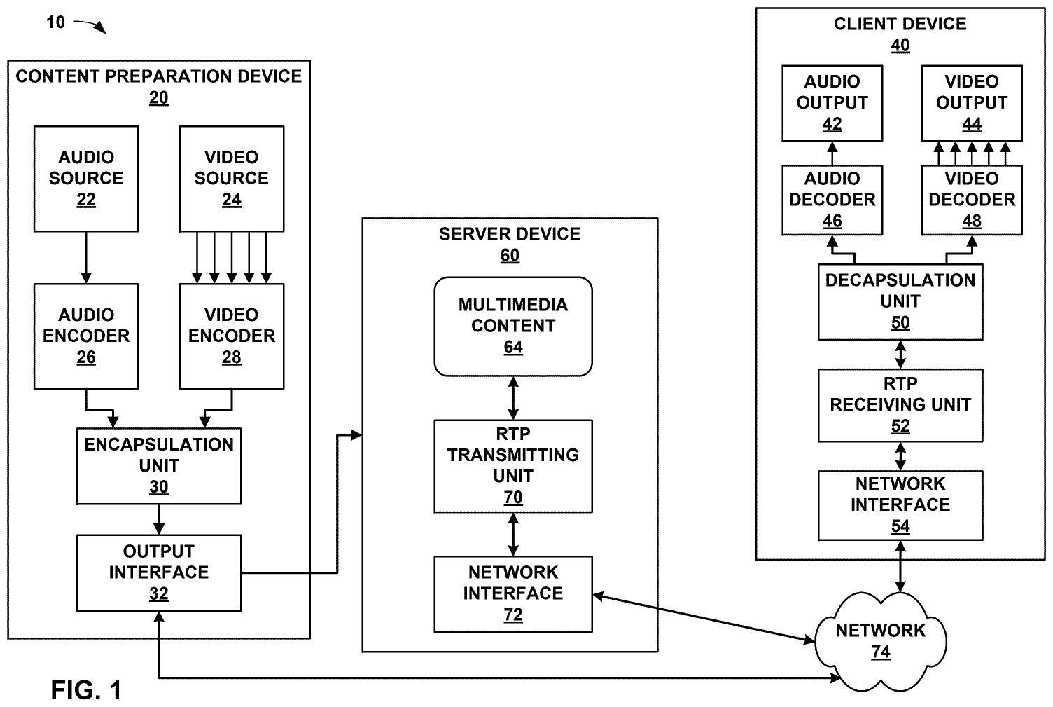

FIG. 1 is a block diagram illustrating an example system 10 that implements techniques for streaming media data over a network. In this example, system 10 includes content preparation device 20, server device 60, and client device 40. Client device 40 and server device 60 are communicatively coupled by network 74, which may comprise the Internet. In some examples, content preparation device 20 and server device 60 may also be coupled by network 74 or another network, or may be directly communicatively coupled. In some examples, content preparation device 20 and server device 60 may comprise the same device.

Content preparation device 20, in the example of FIG. 1, comprises audio source 22 and video source 24. Audio source 22 may comprise, for example, a microphone that produces electrical signals representative of captured audio data to be encoded by audio encoder 26. Alternatively, audio source 22 may comprise a storage medium storing previously recorded audio data, an audio data generator such as a computerized synthesizer, or any other source of audio data. Video source 24 may comprise a video camera that produces video data to be encoded by video encoder 28, a storage medium encoded with previously recorded video data, a video data generation unit such as a computer graphics source, or any other source of video data. Content preparation device 20 is not necessarily communicatively coupled to server device 60 in all examples, but may store multimedia content to a separate medium that is read by server device 60.

Raw audio and video data may comprise analog or digital data. Analog data may be digitized before being encoded by audio encoder 26 and/or video encoder 28. Audio source 22 may obtain audio data from a speaking participant while the speaking participant is speaking, and video source 24 may simultaneously obtain video data of the speaking participant. In other examples, audio source 22 may comprise a computer-readable storage medium comprising stored audio data, and video source 24 may comprise a computer-readable storage medium comprising stored video data. In this manner, the techniques described in this disclosure may be applied to live, streaming, real-time audio and video data or to archived, pre-recorded audio and video data.

Audio frames that correspond to video frames are generally audio frames containing audio data that was captured (or generated) by audio source 22 contemporaneously with video data captured (or generated) by video source 24 that is contained within the video frames. For example, while a speaking participant generally produces audio data by speaking, audio source 22 captures the audio data, and video source 24 captures video data of the speaking participant at the same time, that is, while audio source 22 is capturing the audio data. Hence, an audio frame may temporally correspond to one or more particular video frames. Accordingly, an audio frame corresponding to a video frame generally corresponds to a situation in which audio data and video data were captured at the same time and for which an audio frame and a video frame comprise, respectively, the audio data and the video data that was captured at the same time.

In some examples, audio encoder 26 may encode a timestamp in each encoded audio frame that represents a time at which the audio data for the encoded audio frame was recorded, and similarly, video encoder 28 may encode a timestamp in each encoded video frame that represents a time at which the video data for an encoded video frame was recorded. In such examples, an audio frame corresponding to a video frame may comprise an audio frame comprising a timestamp and a video frame comprising the same timestamp. Content preparation device 20 may include an internal clock from which audio encoder 26 and/or video encoder 28 may generate the timestamps, or that audio source 22 and video source 24 may use to associate audio and video data, respectively, with a timestamp.

In some examples, audio source 22 may send data to audio encoder 26 corresponding to a time at which audio data was recorded, and video source 24 may send data to video encoder 28 corresponding to a time at which video data was recorded. In some examples, audio encoder 26 may encode a sequence identifier in encoded audio data to indicate a relative temporal ordering of encoded audio data but without necessarily indicating an absolute time at which the audio data was recorded, and similarly, video encoder 28 may also use sequence identifiers to indicate a relative temporal ordering of encoded video data. Similarly, in some examples, a sequence identifier may be mapped or otherwise correlated with a timestamp.

Audio encoder 26 generally produces a stream of encoded audio data, while video encoder 28 produces a stream of encoded video data. Each individual stream of data (whether audio or video) may be referred to as an elementary stream. An elementary stream is a single, digitally coded (possibly compressed) component of a media presentation. For example, the coded video or audio part of the media presentation can be an elementary stream. An elementary stream may be converted into a packetized elementary stream (PES) before being encapsulated within a video file. Within the same media presentation, a stream ID may be used to distinguish the PES-packets belonging to one elementary stream from the other. The basic unit of data of an elementary stream is a packetized elementary stream (PES) packet. Thus, coded video data generally corresponds to elementary video streams. Similarly, audio data corresponds to one or more respective elementary streams.

In the example of FIG. 1, encapsulation unit 30 of content preparation device 20 receives elementary streams comprising coded video data from video encoder 28 and elementary streams comprising coded audio data from audio encoder 26. In some examples, video encoder 28 and audio encoder 26 may each include packetizers for forming PES packets from encoded data. In other examples, video encoder 28 and audio encoder 26 may each interface with respective packetizers for forming PES packets from encoded data. In still other examples, encapsulation unit 30 may include packetizers for forming PES packets from encoded audio and video data.

Video encoder 28 may encode video data of multimedia content in a variety of ways, to produce different representations of the multimedia content at various bitrates and with various characteristics, such as pixel resolutions, frame rates, conformance to various coding standards, conformance to various profiles and/or levels of profiles for various coding standards, representations having one or multiple views (e.g., for two-dimensional or three-dimensional playback), or other such characteristics. A representation, as used in this disclosure, may comprise one of audio data, video data, text data (e.g., for closed captions), or other such data. The representation may include an elementary stream, such as an audio elementary stream or a video elementary stream. Each PES packet may include a stream_id that identifies the elementary stream to which the PES packet belongs. Encapsulation unit 30 is responsible for assembling elementary streams into streamable media data.

Encapsulation unit 30 receives PES packets for elementary streams of a media presentation from audio encoder 26 and video encoder 28 and forms corresponding network abstraction layer (NAL) units from the PES packets. Coded video segments may be organized into NAL units, which provide a “network-friendly” video representation addressing applications such as video telephony, storage, broadcast, or streaming. NAL units can be categorized to Video Coding Layer (VCL) NAL units and non-VCL NAL units. VCL units may contain the core compression engine and may include block, macroblock, and/or slice level data. Other NAL units may be non-VCL NAL units. In some examples, a coded picture in one time instance, normally presented as a primary coded picture, may be contained in an access unit, which may include one or more NAL units.

Non-VCL NAL units may include parameter set NAL units and SEI NAL units, among others. Parameter sets may contain sequence-level header information (in sequence parameter sets (SPS)) and the infrequently changing picture-level header information (in picture parameter sets (PPS)). With parameter sets (e.g., PPS and SPS), infrequently changing information need not to be repeated for each sequence or picture; hence, coding efficiency may be improved. Furthermore, the use of parameter sets may enable out-of-band transmission of the important header information, avoiding the need for redundant transmissions for error resilience. In out-of-band transmission examples, parameter set NAL units may be transmitted on a different channel than other NAL units, such as SEI NAL units.

Supplemental Enhancement Information (SEI) may contain information that is not necessary for decoding the coded pictures samples from VCL NAL units, but may assist in processes related to decoding, display, error resilience, and other purposes. SEI messages may be contained in non-VCL NAL units. SEI messages are the normative part of some standard specifications, and thus are not always mandatory for standard compliant decoder implementation. SEI messages may be sequence level SEI messages or picture level SEI messages. Some sequence level information may be contained in SEI messages, such as scalability information SEI messages in the example of SVC and view scalability information SEI messages in MVC. These example SEI messages may convey information on, e.g., extraction of operation points and characteristics of the operation points.

Server device 60 includes Real-time Transport Protocol (RTP) transmitting unit 70 and network interface 72. In some examples, server device 60 may include a plurality of network interfaces. Furthermore, any or all of the features of server device 60 may be implemented on other devices of a content delivery network, such as routers, bridges, proxy devices, switches, or other devices. In some examples, intermediate devices of a content delivery network may cache data of multimedia content 64 and include components that conform substantially to those of server device 60. In general, network interface 72 is configured to send and receive data via network 74.

RTP transmitting unit 70 is configured to deliver media data to client device 40 via network 74 according to RTP, which is standardized in Request for Comment (RFC) 3550 by the Internet Engineering Task Force (IETF). RTP transmitting unit 70 may also implement protocols related to RTP, such as RTP Control Protocol (RTCP), Real-time Streaming Protocol (RTSP), Session Initiation Protocol (SIP), and/or Session Description Protocol (SDP). RTP transmitting unit 70 may send media data via network interface 72, which may implement Uniform Datagram Protocol (UDP) and/or Internet protocol (IP). Thus, in some examples, server device 60 may send media data via RTP and RTSP over UDP using network 74.

RTP transmitting unit 70 may receive an RTSP describe request from, e.g., client device 40. The RTSP describe request may include data indicating what types of data are supported by client device 40. RTP transmitting unit 70 may respond to client device 40 with data indicating media streams, such as media content 64, that can be sent to client device 40, along with a corresponding network location identifier, such as a uniform resource locator (URL) or uniform resource name (URN).

RTP transmitting unit 70 may then receive an RTSP setup request from client device 40. The RTSP setup request may generally indicate how a media stream is to be transported. The RTSP setup request may contain the network location identifier for the requested media data (e.g., media content 64) and a transport specifier, such as local ports for receiving RTP data and control data (e.g., RTCP data) on client device 40. RTP transmitting unit 70 may reply to the RTSP setup request with a confirmation and data representing ports of server device 60 by which the RTP data and control data will be sent. RTP transmitting unit 70 may then receive an RTSP play request, to cause the media stream to be “played,” i.e., sent to client device 40 via network 74. RTP transmitting unit 70 may also receive an RTSP teardown request to end the streaming session, in response to which, RTP transmitting unit 70 may stop sending media data to client device 40 for the corresponding session.

RTP receiving unit 52, likewise, may initiate a media stream by initially sending an RTSP describe request to server device 60. The RTSP describe request may indicate types of data supported by client device 40. RTP receiving unit 52 may then receive a reply from server device 60 specifying available media streams, such as media content 64, that can be sent to client device 40, along with a corresponding network location identifier, such as a uniform resource locator (URL) or uniform resource name (URN).

RTP receiving unit 52 may then generate an RTSP setup request and send the RTSP setup request to server device 60. As noted above, the RTSP setup request may contain the network location identifier for the requested media data (e.g., media content 64) and a transport specifier, such as local ports for receiving RTP data and control data (e.g., RTCP data) on client device 40. In response, RTP receiving unit 52 may receive a confirmation from server device 60, including ports of server device 60 that server device 60 will use to send media data and control data.

After establishing a media streaming session between server device 60 and client device 40, RTP transmitting unit 70 of server device 60 may send media data (e.g., packets of media data) to client device 40 according to the media streaming session. Server device 60 and client device 40 may exchange control data (e.g., RTCP data) indicating, for example, reception statistics by client device 40, such that server device 60 can perform congestion control or otherwise diagnose and address transmission faults.

Network interface 54 may receive and provide media of a selected media presentation to RTP receiving unit 52, which may in turn provide the media data to decapsulation unit 50. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Video encoder 28, video decoder 48, audio encoder 26, audio decoder 46, encapsulation unit 30, RTP receiving unit 52, and decapsulation unit 50 each may be implemented as any of a variety of suitable processing circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 28 and video decoder 48 may be included in one or more encoders or decoders, either of which may be integrated as part of a combined video encoder/decoder (CODEC). Likewise, each of audio encoder 26 and audio decoder 46 may be included in one or more encoders or decoders, either of which may be integrated as part of a combined CODEC. An apparatus including video encoder 28, video decoder 48, audio encoder 26, audio decoder 46, encapsulation unit 30, RTP receiving unit 52, and/or decapsulation unit 50 may comprise an integrated circuit, a microprocessor, and/or a wireless communication device, such as a cellular telephone.

Client device 40, server device 60, and/or content preparation device 20 may be configured to operate in accordance with the techniques of this disclosure. For purposes of example, this disclosure describes these techniques with respect to client device 40 and server device 60. However, it should be understood that content preparation device 20 may be configured to perform these techniques, instead of (or in addition to) server device 60.

Encapsulation unit 30 may form NAL units comprising a header that identifies a program to which the NAL unit belongs, as well as a payload, e.g., audio data, video data, or data that describes the transport or program stream to which the NAL unit corresponds. For example, in H.264/AVC, a NAL unit includes a 1-byte header and a payload of varying size. A NAL unit including video data in its payload may comprise various granularity levels of video data. For example, a NAL unit may comprise a block of video data, a plurality of blocks, a slice of video data, or an entire picture of video data. Encapsulation unit 30 may receive encoded video data from video encoder 28 in the form of PES packets of elementary streams. Encapsulation unit 30 may associate each elementary stream with a corresponding program.

Encapsulation unit 30 may also assemble access units from a plurality of NAL units. In general, an access unit may comprise one or more NAL units for representing a frame of video data, as well as audio data corresponding to the frame when such audio data is available. An access unit generally includes all NAL units for one output time instance, e.g., all audio and video data for one time instance. For example, if each view has a frame rate of 20 frames per second (fps), then each time instance may correspond to a time interval of 0.05 seconds. During this time interval, the specific frames for all views of the same access unit (the same time instance) may be rendered simultaneously. In one example, an access unit may comprise a coded picture in one time instance, which may be presented as a primary coded picture.

Accordingly, an access unit may comprise all audio and video frames of a common temporal instance, e.g., all views corresponding to time X. This disclosure also refers to an encoded picture of a particular view as a “view component.” That is, a view component may comprise an encoded picture (or frame) for a particular view at a particular time. Accordingly, an access unit may include all view components of a common temporal instance. The decoding order of access units need not necessarily be the same as the output or display order.

After encapsulation unit 30 has assembled NAL units and/or access units into a video file based on received data, encapsulation unit 30 passes the video file to output interface 32 for output. In some examples, encapsulation unit 30 may store the video file locally or send the video file to a remote server via output interface 32, rather than sending the video file directly to client device 40. Output interface 32 may comprise, for example, a transmitter, a transceiver, a device for writing data to a computer-readable medium such as, for example, an optical drive, a magnetic media drive (e.g., floppy drive), a universal serial bus (USB) port, a network interface, or other output interface. Output interface 32 outputs the video file to a computer-readable medium, such as, for example, a transmission signal, a magnetic medium, an optical medium, a memory, a flash drive, or other computer-readable medium.

Network interface 54 may receive a NAL unit or access unit via network 74 and provide the NAL unit or access unit to decapsulation unit 50, via RTP receiving unit 52. Decapsulation unit 50 may decapsulate a elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Per techniques of this disclosure, server device 60 may send data of a communication session to client device 40 via a transport protocol, such as Real-time Transport Protocol (RTP) as shown in the example of FIG. 1. Alternatively, other transport protocols, such as QUIC, may be used. When QUIC is used, RTP transmitting unit 70 may instead be considered a QUIC transmitting unit.

Server device 60 may send data of the communication session with client device 40 in data bursts, where a data burst may include a set of protocol data units (PDUs), i.e., a PDU Set. In general, a PDU Set may include all media data to be presented together at a common temporal instance, and each PDU may include data to be included at that common temporal instance. For example, slices of a frame of video data may be encapsulated and transmitted as a PDU. As such, a PDU Set may correspond to an access unit, as discussed above.

Accordingly, server device 60 may construct a PDU Set for transmission in a data burst. Before having completely formed the PDU Set for a current data burst, server device 60 may predict a size of the current data burst. RTP transmitting unit 70 may encapsulate an ordinal first PDU of the PDU Set for the current data burst with data indicating the predicted size of the current data burst as a burst size (BSSize) value. For example, RTP transmitting unit 70 may encapsulate the ordinal first PDU with an RTP header extension that signals the BSSize value (as a predicted BSSize value). The same RTP header extension, or a different RTP header extension, may also indicate a time to next burst (TTNB) value, which may indicate a time between the end of the current data burst to a time at which a subsequent data burst will begin, where this time between data bursts represents a time during which server device 60 will not send time-sensitive data of the communication session. When QUIC is used, server device 60 may instead encapsulate the ordinal first PDU with one or more QUIC header extensions signaling the time to next burst and burst size values.

While constructing the PDU Set for the current data burst, server device 60 may determine that additional data is to be sent for the current data burst. For example, server device 60 may receive additional data for a different PDU Set or additional data for the current PDU Set. Thus, server device 60 may determine that the previously predicted burst size for the current data burst is not accurate. Therefore, server device 60 may encapsulate a subsequent PDU of the PDU Set with an RTP header extension (or QUIC header extension) including data indicating how the previous predicted burst size value is to be updated to account for the new burst size. For example, server device 60 may signal an offset relative to the predicted BSSize value or an entirely new BSSize value representing the total size of the current data burst.

Client device 40 may represent a user equipment (UE) device that is communicatively coupled to server device 60 via a radio access network (RAN). The RAN may include a base station, such as a gNB (not shown in FIG. 1). The base station may use the time to next burst, predicted burst size, and updated (actual) burst size information to perform resource allocation, as discussed above. The base station may also configure client device 40 to disable RTP receiving unit 52 (e.g., receiving circuitry) for a period of time between an end of a current data burst and a next data burst of the communication session. In this manner, client device 40 may disable RTP receiving unit 52 for this period of time, which may save processing power and thereby conserve battery power, when client device 40 is powered by a battery.

The base station and/or client device 40 may also, during establishment of the communication session, communicate support for variable burst size information. For example, the base station and/or client device 40 may send a session description protocol (SDP) message indicating whether the base station and/or client device 40 support updating burst size information per the techniques of this disclosure, e.g., for RTP sessions. For QUIC, the base station and/or client device 40 may send such information in one or more of a QUIC Initial packet, a QUIC handshake packet, or a QUIC 1-RTT packet, and the information may be a transport parameter indicating whether such burst size updates are supported.

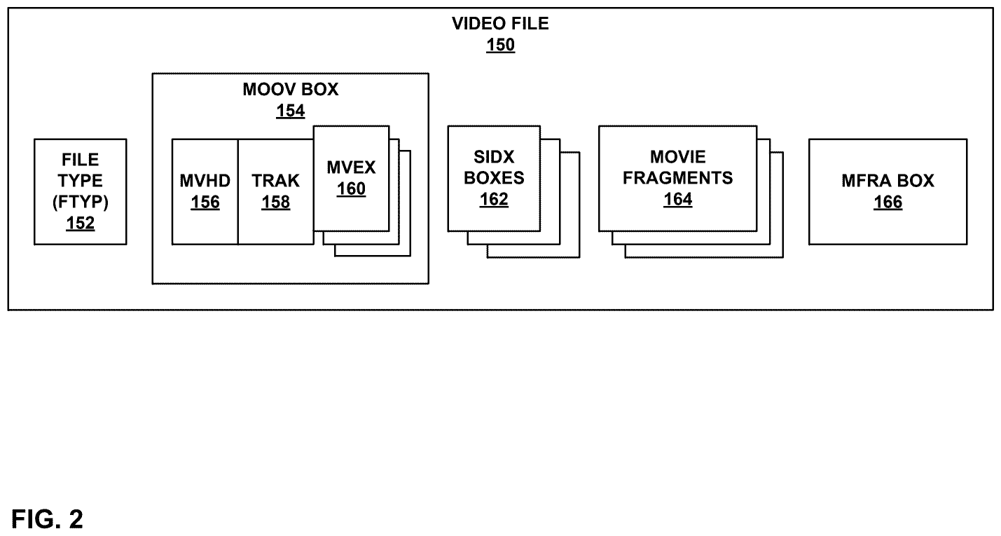

FIG. 2 is a block diagram illustrating elements of an example video file 150. As described above, video files in accordance with the ISO base media file format and extensions thereof store data in a series of objects, referred to as “boxes.” In the example of FIG. 2, video file 150 includes file type (FTYP) box 152, movie (MOOV) box 154, segment index (sidx) boxes 162, movie fragment (MOOF) boxes 164, and movie fragment random access (MFRA) box 166. Although FIG. 2 represents an example of a video file, it should be understood that other media files may include other types of media data (e.g., audio data, timed text data, or the like) that is structured similarly to the data of video file 150, in accordance with the ISO base media file format and its extensions.

File type (FTYP) box 152 generally describes a file type for video file 150. File type box 152 may include data that identifies a specification that describes a best use for video file 150. File type box 152 may alternatively be placed before MOOV box 154, movie fragment boxes 164, and/or MFRA box 166.

MOOV box 154, in the example of FIG. 2, includes movie header (MVHD) box 156, track (TRAK) box 158, and one or more movie extends (MVEX) boxes 160. In general, MVHD box 156 may describe general characteristics of video file 150. For example, MVHD box 156 may include data that describes when video file 150 was originally created, when video file 150 was last modified, a timescale for video file 150, a duration of playback for video file 150, or other data that generally describes video file 150.

TRAK box 158 may include data for a track of video file 150. TRAK box 158 may include a track header (TKHD) box that describes characteristics of the track corresponding to TRAK box 158. In some examples, TRAK box 158 may include coded video pictures, while in other examples, the coded video pictures of the track may be included in movie fragments 164, which may be referenced by data of TRAK box 158 and/or sidx boxes 162.

In some examples, video file 150 may include more than one track. Accordingly, MOOV box 154 may include a number of TRAK boxes equal to the number of tracks in video file 150. TRAK box 158 may describe characteristics of a corresponding track of video file 150. For example, TRAK box 158 may describe temporal and/or spatial information for the corresponding track. A TRAK box similar to TRAK box 158 of MOOV box 154 may describe characteristics of a parameter set track, when encapsulation unit 30 (FIG. 1) includes a parameter set track in a video file, such as video file 150. Encapsulation unit 30 may signal the presence of sequence level SEI messages in the parameter set track within the TRAK box describing the parameter set track.

MVEX boxes 160 may describe characteristics of corresponding movie fragments 164, e.g., to signal that video file 150 includes movie fragments 164, in addition to video data included within MOOV box 154, if any. In the context of streaming video data, coded video pictures may be included in movie fragments 164 rather than in MOOV box 154. Accordingly, all coded video samples may be included in movie fragments 164, rather than in MOOV box 154.

MOOV box 154 may include a number of MVEX boxes 160 equal to the number of movie fragments 164 in video file 150. Each of MVEX boxes 160 may describe characteristics of a corresponding one of movie fragments 164. For example, each MVEX box may include a movie extends header box (MEHD) box that describes a temporal duration for the corresponding one of movie fragments 164.

As noted above, encapsulation unit 30 may store a sequence data set in a video sample that does not include actual coded video data. A video sample may generally correspond to an access unit, which is a representation of a coded picture at a specific time instance. In the context of AVC, the coded picture include one or more VCL NAL units, which contain the information to construct all the pixels of the access unit and other associated non-VCL NAL units, such as SEI messages. Accordingly, encapsulation unit 30 may include a sequence data set, which may include sequence level SEI messages, in one of movie fragments 164. Encapsulation unit 30 may further signal the presence of a sequence data set and/or sequence level SEI messages as being present in one of movie fragments 164 within the one of MVEX boxes 160 corresponding to the one of movie fragments 164.

SIDX boxes 162 are optional elements of video file 150. That is, video files conforming to the 3GPP file format, or other such file formats, do not necessarily include SIDX boxes 162. In accordance with the example of the 3GPP file format, a SIDX box may be used to identify a sub-segment of a segment (e.g., a segment contained within video file 150). The 3GPP file format defines a sub-segment as “a self-contained set of one or more consecutive movie fragment boxes with corresponding Media Data box(es) and a Media Data Box containing data referenced by a Movie Fragment Box must follow that Movie Fragment box and precede the next Movie Fragment box containing information about the same track.” The 3GPP file format also indicates that a SIDX box “contains a sequence of references to subsegments of the (sub)segment documented by the box. The referenced subsegments are contiguous in presentation time. Similarly, the bytes referred to by a Segment Index box are always contiguous within the segment. The referenced size gives the count of the number of bytes in the material referenced.”

SIDX boxes 162 generally provide information representative of one or more sub-segments of a segment included in video file 150. For instance, such information may include playback times at which sub-segments begin and/or end, byte offsets for the sub-segments, whether the sub-segments include (e.g., start with) a stream access point (SAP), a type for the SAP (e.g., whether the SAP is an instantaneous decoder refresh (IDR) picture, a clean random access (CRA) picture, a broken link access (BLA) picture, or the like), a position of the SAP (in terms of playback time and/or byte offset) in the sub-segment, and the like.

Movie fragments 164 may include one or more coded video pictures. In some examples, movie fragments 164 may include one or more groups of pictures (GOPs), each of which may include a number of coded video pictures, e.g., frames or pictures. In addition, as described above, movie fragments 164 may include sequence data sets in some examples. Each of movie fragments 164 may include a movie fragment header box (MFHD, not shown in FIG. 2). The MFHD box may describe characteristics of the corresponding movie fragment, such as a sequence number for the movie fragment. Movie fragments 164 may be included in order of sequence number in video file 150.

MFRA box 166 may describe random access points within movie fragments 164 of video file 150. This may assist with performing trick modes, such as performing seeks to particular temporal locations (i.e., playback times) within a segment encapsulated by video file 150. MFRA box 166 is generally optional and need not be included in video files, in some examples. Likewise, a client device, such as client device 40, does not necessarily need to reference MFRA box 166 to correctly decode and display video data of video file 150. MFRA box 166 may include a number of track fragment random access (TFRA) boxes (not shown) equal to the number of tracks of video file 150, or in some examples, equal to the number of media tracks (e.g., non-hint tracks) of video file 150.

In some examples, movie fragments 164 may include one or more stream access points (SAPs), such as IDR pictures. Likewise, MFRA box 166 may provide indications of locations within video file 150 of the SAPs. Accordingly, a temporal sub-sequence of video file 150 may be formed from SAPs of video file 150. The temporal sub-sequence may also include other pictures, such as P-frames and/or B-frames that depend from SAPs. Frames and/or slices of the temporal sub-sequence may be arranged within the segments such that frames/slices of the temporal sub-sequence that depend on other frames/slices of the sub-sequence can be properly decoded. For example, in the hierarchical arrangement of data, data used for prediction for other data may also be included in the temporal sub-sequence.

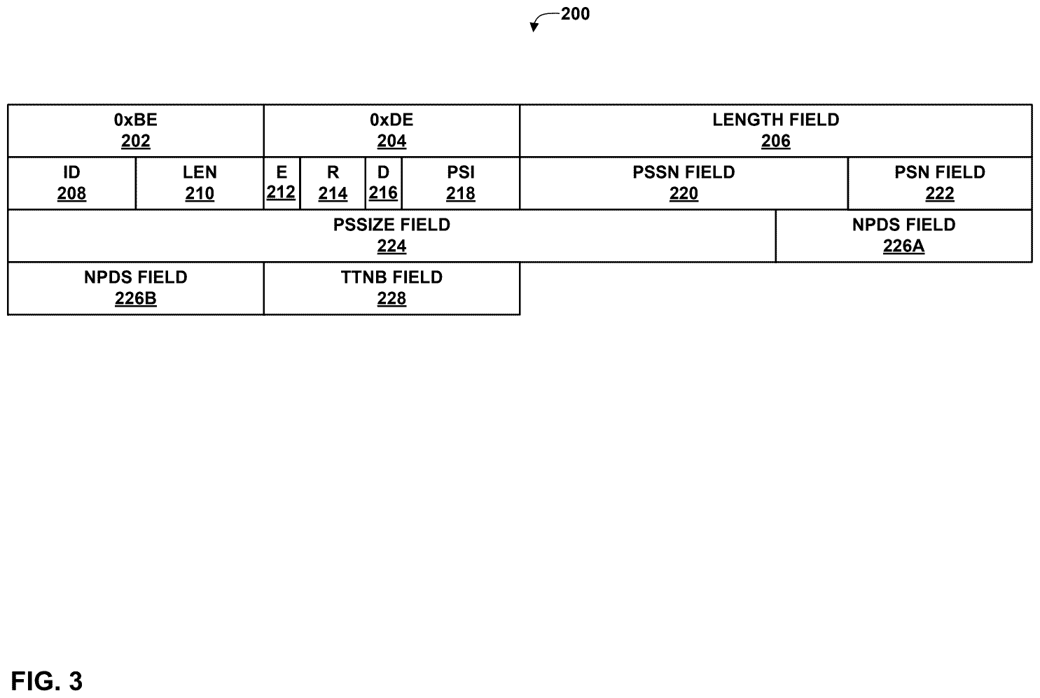

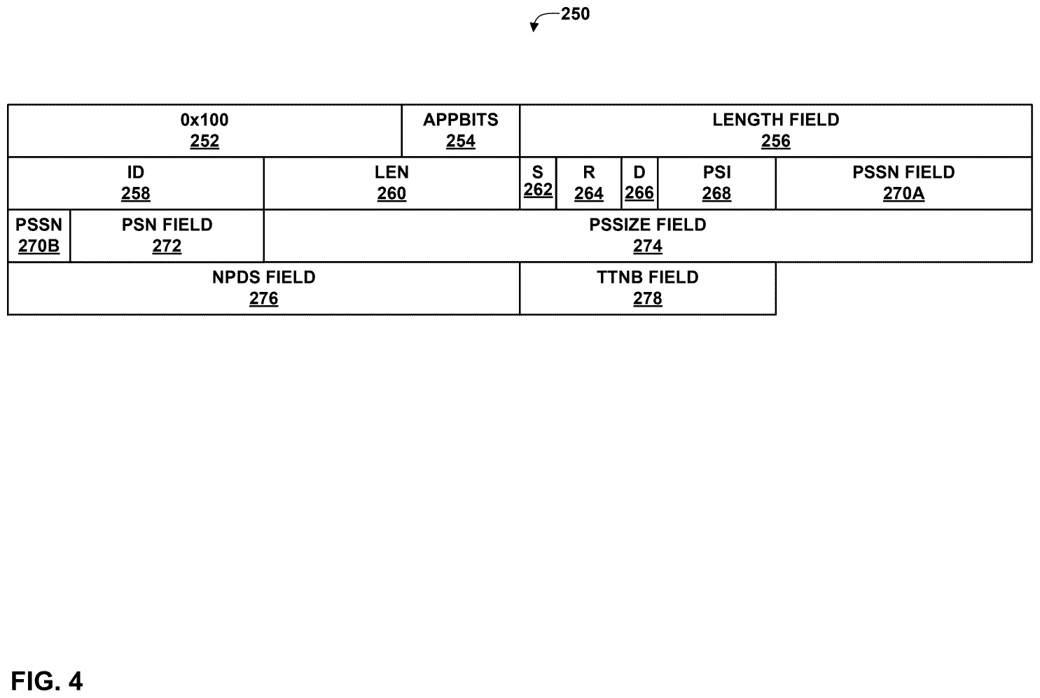

FIGS. 3 and 4 are conceptual diagrams illustrating respective examples of RTP header extensions for signaling the starting time of a time to the next data burst (TNDB). As discussed above, in general, the TNDB may correspond to the first PDU set of the current data burst or the last PDU of the current data burst. In the examples of FIGS. 3 and 4, as discussed below, the TNDB may be signaled as either corresponding to the first PDU or the last PDU of the current data burst.

In some examples, the RTP header extension for PDU Set marking may signal whether the TNDB corresponds to the first PDU or the last PDU of the current burst. The existing RTP header extension for PDU Set marking may be modified to introduce one or two newly defined bits to indicate the start time of the TTNB. An existing reserved bit of the RTP header extension for PDU Set marking may be used for the indication. The indication may be by a codepoint of the existing reserved field, e.g., R=10 indicates the first PDU or R=01 indicates the last PDU.

FIG. 3 is a conceptual diagram illustrating an example one-byte format for an RTP header extension 200 for PDU set marking per techniques of this disclosure. In this example, RTP header extension 200 includes hex value 0×BE 202 (8 bits), hex value 0×DE 204 (8 bits), length field 206 (16 bits), identifier (ID) value 208 (4 bits), length (len) value 210 (4 bits), E bit 212, R bits 214 (2 bits), D bit 216, PSI bits 218 (4 bits), PSSN field 220 (10 bits), PSN field 222 (6 bits), PSSize field 224 (24 bits), NPDS fields 226A, 226B (total of 16 bits), and NTDB field 228 (8 bits). In this example, the value of R bits 214 may be set to 10 to indicate that the TNBD value corresponds to the first PDU of the burst, whereas the value of R bits 214 may be set to 01 to indicate that the TNBD value corresponds to the last PDU of the burst.

FIG. 4 is a conceptual diagram illustrating an example two-byte format for an RTP header extension 250 for PDU set marking per techniques of this disclosure. In this example, RTP header extension 250 includes hex value 0×100 252 (12 bits), appbits 254 (4 bits), length field 256 (16 bits), ID value 258 (8 bits), len value 260 (8 bits), S bit 262, R bits 264 (2 bits), D bit 266, PSI value 268 (4 bits), PSSN fields 270A, 270B (total of 10 bits), PSN field 272 (6 bits), PSSize field 274 (24 bits), NPDS field 276 (16 bits), and NTDB field 278 (8 bits). In this example, the value of R bits 264 may be set to 10 to indicate that the TNBD value corresponds to the first PDU of the burst, whereas the value of R bits 264 may be set to 01 to indicate that the TNBD value corresponds to the last PDU of the burst.

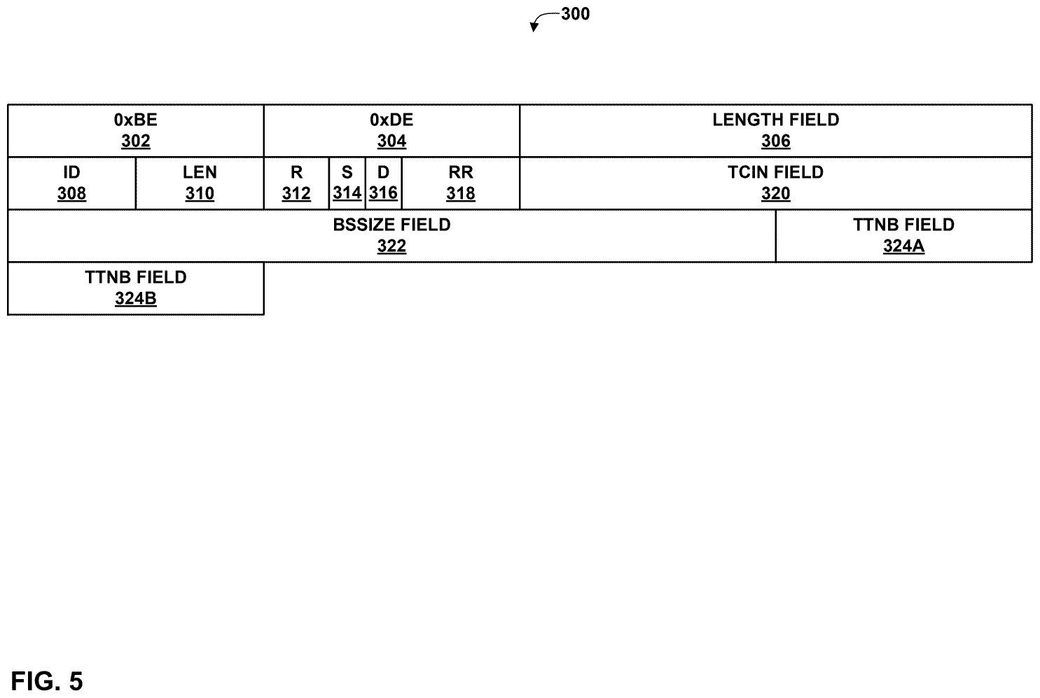

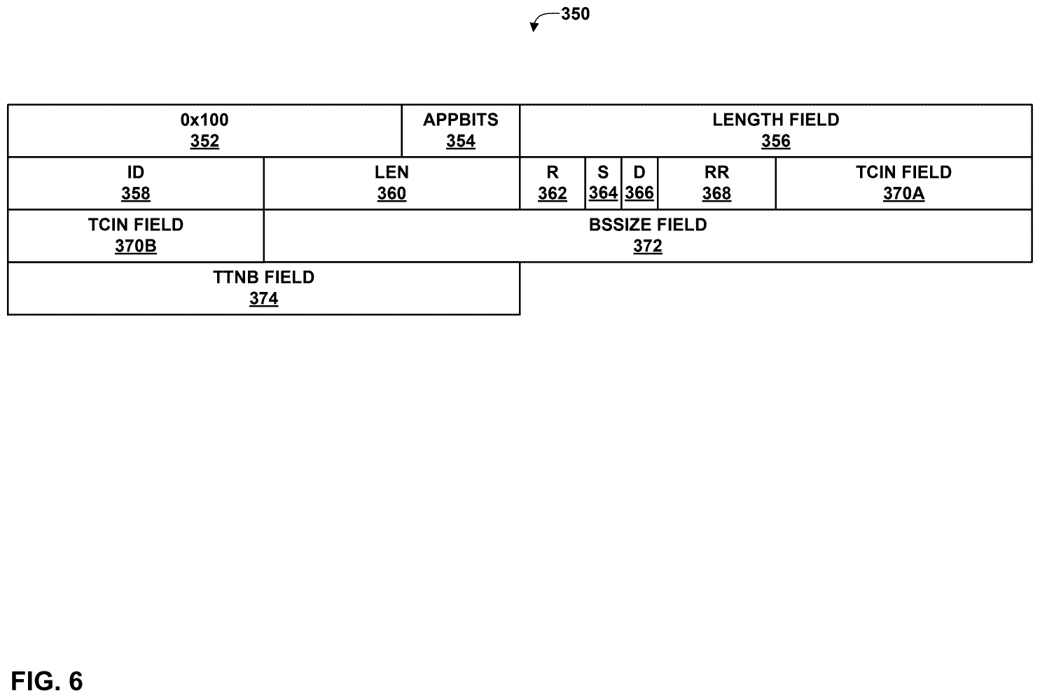

In some examples, a dedicated RTP header extension for data burst traffic characteristics may be modified to indicate whether a TNDB value corresponds to a first PDU of the current burst or a last PDU of the current burst. Examples are shown in FIGS. 5 and 6, as discussed below. In general, reserved bits of the RTP header extension for data burst traffic characteristics may be used to signal whether the TNDB value corresponds to the first PDU of the current burst or the last PDU of the current burst, as discussed below.

FIG. 5 is a conceptual diagram illustrating an example one-byte format for an RTP header extension 300 for data burst traffic characteristics per techniques of this disclosure. In this example, RTP header extension 300 includes hex value 0×BE 302 (8 bits), hex value 0×DE 304 (8 bits), length field 306 (16 bits), identifier (ID) value 308 (4 bits), length (len) value 310 (4 bits), R bits 312 (2 bits), S bit 314, D bit 316, RR field 318 (4 bits), TCIN field 320 (16 bits), BSSize field 322 (24 bits), and TTNB fields 324A, 324B (total of 16 bits). In this example, the value of S bit 314 may be set to 1 to indicate that the TNBD value corresponds to the first PDU of the burst, whereas the value of S bits 314 may be set to 0 to indicate that the TNBD value corresponds to the last PDU of the burst.

FIG. 6 is a conceptual diagram illustrating an example two-byte format for an RTP header extension 350 for data burst traffic characteristics per techniques of this disclosure. In this example, RTP header extension 350 includes hex value 0×100 352 (12 bits), appbits 354 (4 bits), length field 356 (16 bits), ID value 358 (8 bits), len value 360 (8 bits), R bits 362 (2 bits), S bit 364, D bit 366, RR bits 368 (4 bits), TCIN fields 370A, 370B (16 bits total), BSSize field 372 (24 bits), and TTNB field 374 (16 bits). In this example, the value of S bit 364 may be set to 1 to indicate that the TNBD value corresponds to the first PDU of the burst, whereas the value of S bit 364 may be set to 0 to indicate that the TNBD value corresponds to the last PDU of the burst. Because R bits 362 are reserved, the expected value of R bits 362 may be 00, thus the value of R bits 362 in combination with the value of S bit 364 may be 001 to indicate that the TNBD value corresponds to the first PDU of the burst or 000 to indicate that the TNDB value corresponds to the last PDU of the burst.

In addition or in the alternative, the accuracy of the TNDB value may be indicated by a field in an RTP header extension. This indication may include an integer component and a fractional component. The indication may represent jitter, standard deviation, or confidence interval. A value of y of the indication may mean+/−y units of time. The TNDB x with accuracy y may then be interpreted as x+/−y time units. For example, if the indication has 8 bits, the four most significant bits may represent the integer component and the four least significant bits may represent the fractional component. Assuming that the unit is in milliseconds, then the range may be from 0 to 16-1/256=15.996 ms for y. The RTP header extension may be RTP header extension for PDU set marking or the RTP header extension for data burst traffic characteristics.

In addition or in the alternative, the accuracy of the size of the next data burst (SNDB) may be indicated in a field of an RTP header extension. The indication may represent a jitter, standard deviation, or a confidence interval. In one example, a value y of the indication means+/−y units of data. The SNDB x with accuracy y may be interpreted as x+/−y data units. For example, the indication may have 8 bits, and the data unit may be 32 bits. As another example, the value may indicate relative error. For example, a value a of the indication may mean+/−a of the indicated SNDB, and SNDB x with accuracy a may be interpreted as x(1+/−a). For example, the indication may have 8 bits and represent a fractional number with the decimal point to the left of the MSB, hence 01000000 may mean 0.25 in decimal. The RTP header extension may be the RTP header extension for PDU Set marking with a new field for the indication, or the RTP header extension for data burst with a new field for the indication.

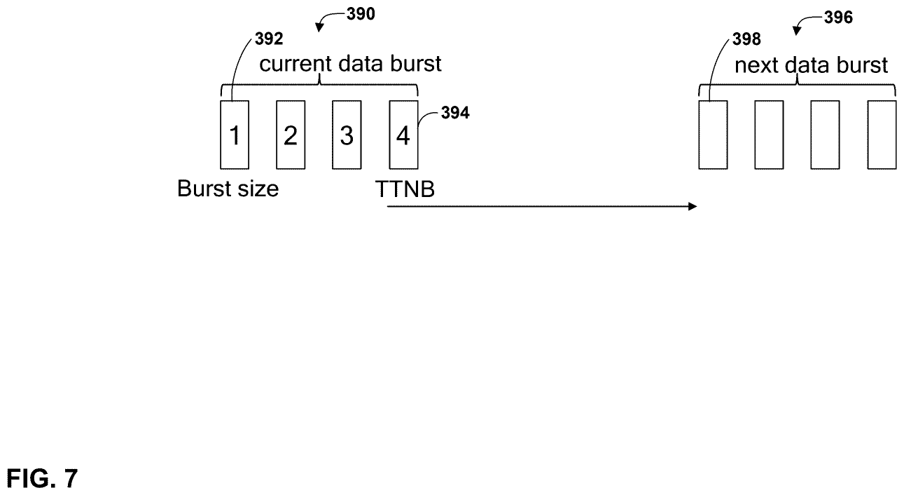

FIG. 7 is a conceptual diagram illustrating example data bursts and protocol data units (PDUs) thereof. In this example, FIG. 7 depicts current data burst 390 and next data burst 396, each of which includes a respective PDU Set.

In general, data indicating a burst size may be sent in an ordinal first PDU of a data burst to which the burst size applies. Likewise, a time to next burst (TTNB) value, or a TNDB value, may represent the time difference between the departure time of an ordinal last PDU of the data burst and the departure time of the ordinal first PDU of the next data burst. That is, the TTNB value (or TNDB value) may represent a time period (or silent period) during which the traffic source guarantees not to send any delay-sensitive PDUs, as shown in FIG. 7.

In particular, in the example of FIG. 7, an ordinal first PDU 392 of current data burst 390 may include data indicating a burst size for current data burst 390. As discussed above, such burst size data may be carried in an RTP header extension or a QUIC header extension. Likewise, a TTNB value for current data burst 390 represents a time period (or silent period) between a departure time of ordinal last PDU 394 of current data burst 390 and a departure time of ordinal first PDU 398 of next data burst 396.

Moreover, per techniques of this disclosure, ordinal first PDU 392 of current data burst 390 may include data (e.g., an RTP header extension or QUIC header extension) including a predicted burst size (BSSize) value for current data burst 390. At some point, a sending device may determine that this predicted BSSize value was inaccurate. Therefore, the sending device may encapsulate a subsequent PDU of the PDU Set with data indicating how the predicted BSSize value is to be modified (e.g., offset or replaced) with size data to obtain an actual BSSize value for current data burst 390.

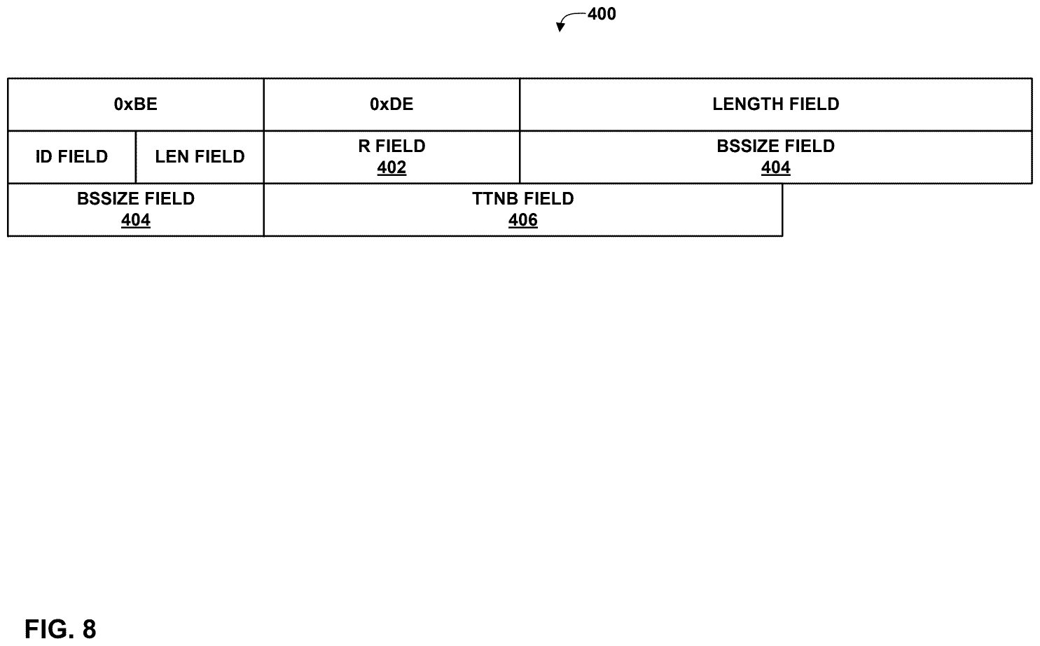

FIG. 8 is a conceptual diagram illustrating an example Real-time Transport Protocol (RTP) header extension 400 that may be used to signal data burst traffic characteristics per techniques of this disclosure. In this example, RTP header extension 400 includes, among other fields, a reserved (R) field 402, burst size (BSSize) field 404, and time to next burst (TTNB) field 406. R field 402 is an eight-bit field in this example and is reserved for future usage. R field 402 may have a value of 0 for all eight bits as set by a sending device and may be ignored by a receiving device.

BSSize field 404 is a 24-bit field in this example. The value of BSSize field 404 may indicate a total size of the burst to be transmitted in bytes (including the overhead of RTP header extension 400). If the burst size is not known, the value of BSSize field 404 may be set to zero.

TTNB field 406 is a 16-bit field in this example. The value of TTNB field 406 may indicate an approximate time, in tenths of a millisecond, to the next burst. If the time is not known, the value of TTNB field 406 may be set to a reserved value of 65535.

Per techniques of this disclosure, an ordinal first PDU of a current data burst may be encapsulated with RTP header extension 400 to indicate both a predicted BSSize value and a TTNB value. If the sending device determines that the predicted BSSize value was inaccurate, the sending device may update the BSSize value (e.g., with data indicating an offset or a replacement value). Thus, a receiving device may receive the update to the BSSize value to determine an actual BSSize value for the current data burst. The receiving device may be, for example, a base station, which may perform a new resource allocation procedure based on the actual BSSize value, to ensure that all PDUs of the PDU Set of the current data burst are received correctly. The base station may also reconfigure a communicatively coupled UE participating in the communication session based on the actual BSSize value, e.g., to disable reception circuitry for a time period between having received all PDUs of the current data burst and a time at which a subsequent data burst is to begin transmission.

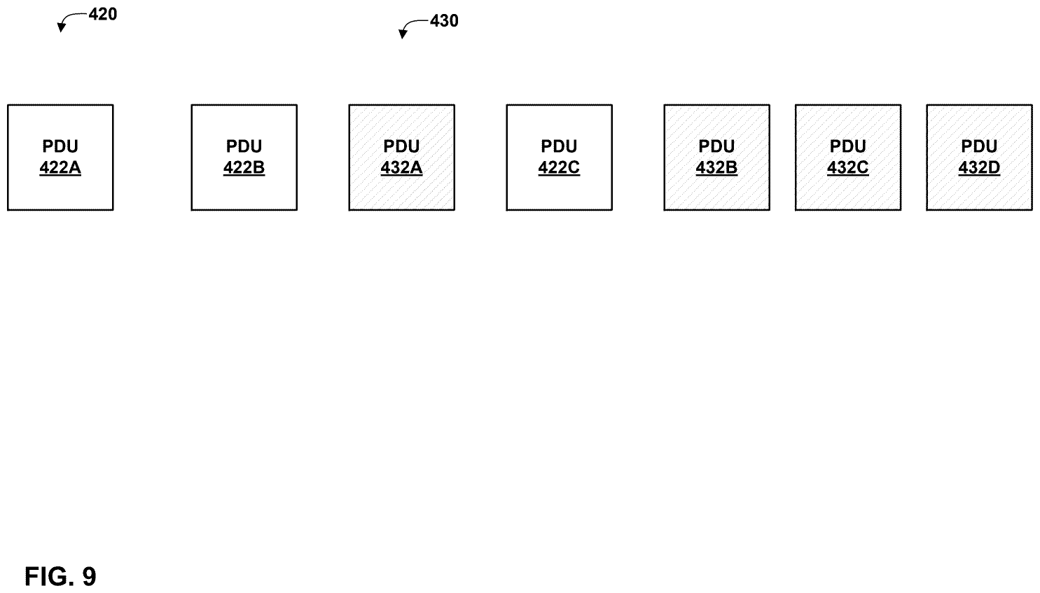

FIG. 9 is a conceptual diagram illustrating an example sequence of PDUs sent as part of a data burst. In some instances, constituent PDUs of a data burst may increase after the data burst indication has been sent. The example of FIG. 9 depicts current burst 420 and next burst 430. Current burst 420 includes white-shaded blocks representing PDUs, namely, PDUs 422A, 422B, and 422C. Next burst 430 includes grey-shaded blocks representing PDUs, namely, PDUs 432A, 432B, 432C, and 432D.

In this example, current burst 420 includes three audio PDUs, i.e., PDUs 422A-422C. Encoding of a video frame may be finished after an ordinal first audio PDU (e.g., PDU 422A) was sent. PDU 422A may include an RTP header extension indicating that current burst 420 includes a data burst size (BSSize) of 3000B. Video PDUs, i.e., PDUs 432A-432D, may be created and sent before the end of current burst 420, i.e., a current audio data burst. Each of PDUs 422A-422C may be assumed to be 1000 bytes in this example, and each of PDUs 432A-432D may be assumed to be 1000 bytes in this example.

Current burst 420 may incorporate video PDUs 432A-432D and become a new data burst. The BSSize of the new data burst, in this example, is much larger than 3000 bytes (namely, 7000 bytes, in this example), due to inclusion of each of PDUs 422A-422C and PDUs 432A-432D. A traffic source may therefore need to update the BSSize value, preferably in first video PDU 432A.

Alternatively, the original BSSize indication of 3000 bytes may be kept accurate by delaying transmission of video PDUs 432A-432D until after PDU 422C has been sent. However, this would increase the delay of the video data burst, which may cause poor performance through introduction of latency, which may diminish performance of certain applications, such as AR/XR applications.

Accordingly, this disclosure describes techniques that may be used to indicate an updated BSSize value. A traffic source, such as server device 60 of FIG. 1, may indicate an update to a previously signaled BSSize value if one or more PDUs not belonging to the current data burst are sent after transmission of an ordinal first PDU of the current data burst and before transmission of the ordinal last PDU of the current data burst to form a new data burst. This indication may be included in a header extension (e.g., an RTP header extension or a QUIC header extension) of a second or subsequent PDU following the ordinal first PDU of the current data burst.

One or more PDUs not belonging to the current data burst may or may not be delay sensitive. If the one or more PDUs are delay sensitive, the BSSize value may be updated to avoid delay that may otherwise be caused by a base station not obtaining enough resource allocation based on the outdated BSSize information. If the one or more PDUs are not delay sensitive, the BSSize value may still need to be updated because the base station cannot distinguish delay sensitive from non-delay sensitive PDUs. Alternatively, the source device may delay transmission of the non-delay sensitive PDUs, e.g., until the end of the current data burst.

A subsequent PDU including an updated BSSize value may be one of the PDUs not belonging to the current data burst. The updated BSSize value may indicate the size of the remaining PDUs of the new data burst or the size of all of the PDUs of the new data burst. The BSSize value indicating a size of the remaining PDUs of the new data burst may simplify operation at a network entity (e.g., a base station, such as a gNB), because the network entity only needs to allocate resources for the remaining PDUs of the new data burst. The BSSize value indicating a size of all of the PDUs of the new data burst may require the network entity to keep a state variable to store the BSSize of the current data burst and to adjust resource allocation based on the updated BSSize value.

A traffic source may include data indicating that the updated BSSize value is an update to a previously transmitted BSSize value. Such data may be included in the same PDU that includes the updated BSSize value. This indication may be carried out using a new bit or a reserved bit, e.g., in the RTP header extension or in the QUIC header extension. A bit value of 1 may indicate that the BSSize value is an updated BSSize value, and therefore, the previous BSSize value is obsolete and should be ignored or updated by a receiving network entity. A bit value of 0 may indicate that the BSSize is not an update of a previous BSSize value, and therefore, the BSSize value carried in the PDU does not make the previous BSSize value obsolete.

This data may be signaled as an option during session setup. For example, session description protocol (SDP) signaling may be used to signal whether data for a new BSSize value of a current data burst may override/render obsolete a previously sent BSSize value for the current data burst. If the PDUs are carried by RTP packets, an example augmented Backus-Naur form (ABNF) syntax for the data may be:
extensionname=“urn:3gpp:sa4:5grtp: dynamic-traffic-characteristics-rel19”
extensionattributes=[format SP][BSSize-update]
   where the presence of BSSize-update indicates support for BSSize update, and absence indicates no support for such updates.

Additionally or alternatively, various other messages (e.g., Initial packets, handshake packets, 1-RTT packets of QUIC) may include BSSize update negotiation data, e.g., as a transport parameter. For example, during a QUIC handshake phase, both a sending device and a receiving device may send transport parameters as declarations that are made unilaterally indicating support of various features, such as BSSize update data per techniques of this disclosure.

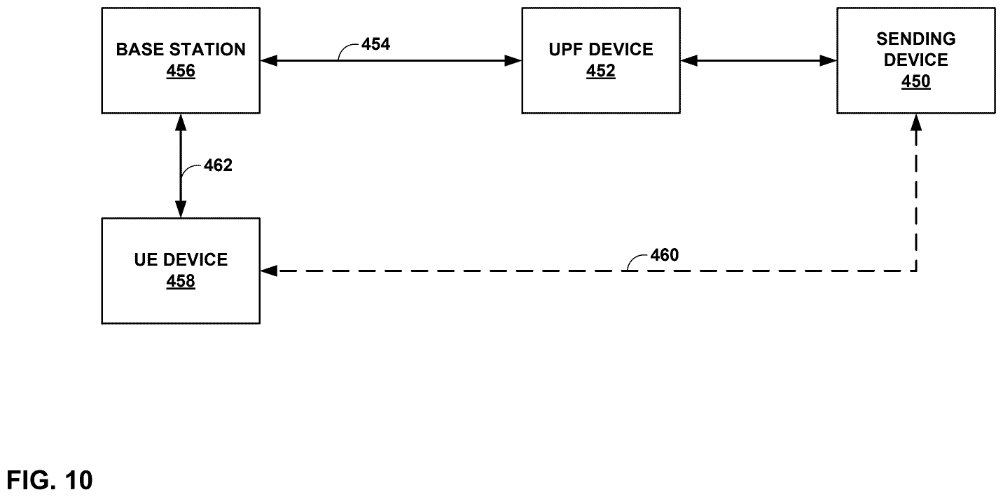

FIG. 10 is a block diagram illustrating an example set of network devices that may perform various aspects of the techniques of this disclosure. The example of FIG. 10 depicts sending device 450, user plane function (UPF) device 452, base station 456, and user equipment (UE) device 458. Sending device 450 may correspond to server device 60 and/or content preparation device 20 of FIG. 1. UE device 458 may correspond to client device 40 of FIG. 1.

Sending device 450 (e.g., an application server (AS) device) may obtain video data to be sent to UE device 458 via communication session 460. To send the video data to UE device 458, sending device 450 may encode the video data (or receive encoded video data from an encoding device, not shown in FIG. 10). Sending device 450 may encapsulate packets including encoded video data (e.g., encoded slices of frames of video data) to form real-time transport protocol (RTP) packets. Such RTP packets may correspond to PDUs of respective data bursts.

Sending device 450 may add an RTP header extensions to certain PDUs to indicate burst size data for a current data burst. For example, sending device 450 may add such RTP header extensions to ordinal first PDUs and/or to PDUs indicating a burst size update for the current data burst. As the RTP packets are formed, sending device 450 may send the RTP packets to UE device 458 via a network including UPF device 452. Although not shown in FIG. 10, there may be additional network devices between sending device 450 and UPF device 452, e.g., various network routing devices, gateways, bridges, switches, or the like.

UPF device 452 may receive the RTP packets from sending device 450 and form GTP-U tunneled packets. For example, UPF device 452 may encapsulate the RTP packets with respective GTP-U headers. Per techniques of this disclosure, UPF device 452 may extract the burst size data from the RTP header extensions of the RTP packets, e.g., from respective RTP header extensions. UPF device 452 may then form the GTP-U headers to include corresponding burst size data. UPF device 452 may send the GTP-U packets to base station 456 via network tunnel 454. Network tunnel 454 may include other network devices, such as network routing devices, configured to forward the GTP-U packets along network tunnel 454 to base station 456.

Base station 456 may receive the GTP-U packets and decapsulate the GTP-U packets to reproduce the RTP packets. Base station 456 may allocate resources to reception of the GTP-U packets based on the burst size data (and reallocate resources in response to burst size updates). For example, base station 456 may instruct UE device 458 to disable data reception after the total amount of data corresponding to the burst size for the current data burst has been received for a period of time corresponding to a signaled time to next burst (e.g., TTNB or TNBD value) per techniques of this disclosure. Base station 456 may then send the RTP packets to UE device 458 via radio access network (RAN) connection 462.

UE device 458 may receive the RTP packets from base station 456 via RAN connection 462. In particular, UE device 458 may be a battery powered device, such as a cellphone. Thus, to preserve battery power, UE device 458 may disable reception of packets for communication session 460 via RAN connection 462 for idle period times indicated by the TNBD/TTNB values following reception of all data for the current data burst as indicated by the burst size data. For example, during idle period times, UE device 458 may power down reception circuitry, then power up the reception circuitry at the end of the idle period.

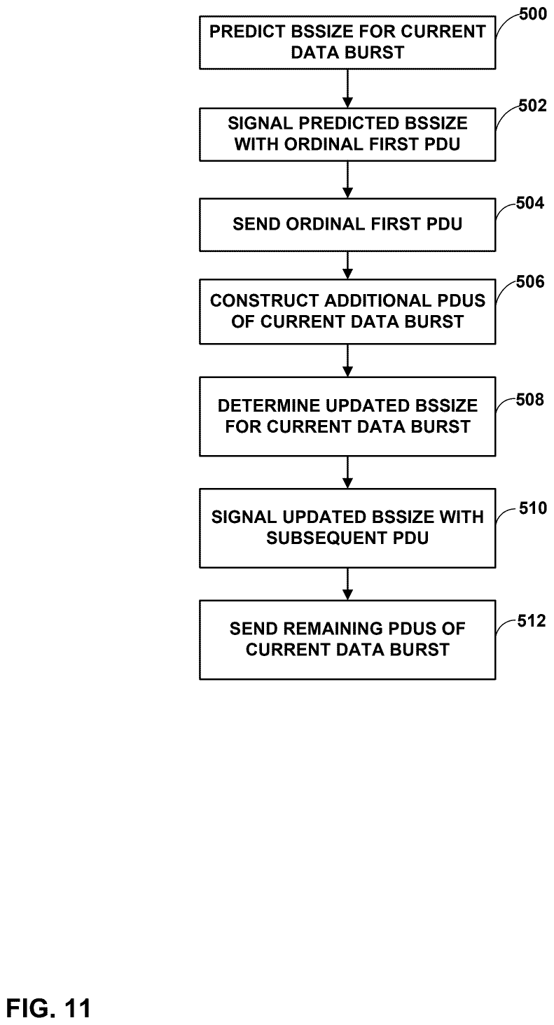

FIG. 11 is a flowchart illustrating an example method for sending data of a communication session per techniques of this disclosure. The method of FIG. 11 may be performed by a sending device, such as server device 60 of FIG. 1 or sending device 450 of FIG. 10. For purposes of example and explanation, the method of FIG. 11 is explained with respect to sending device 450 of FIG. 10.

Initially, sending device 450 may perform a session negotiation for a communication session with a receiving device, such as UE device 458 and/or base station 456 of FIG. 10. The session negotiation may include receiving, from the receiving device, data indicating whether the receiving device supports updating a data burst size (BSSize) value for a current data burst while the current data burst is being sent per techniques of this disclosure. For example, sending device 450 may receive a session description protocol (SDP) message from the receiving device indicating whether the receiving device supports BSSize value updates per these techniques. As another example, sending device 450 may receive a transport parameter indicating support for data burst size updates for the data bursts of the communication session, e.g., in one or more of a QUIC Initial packet, a QUIC handshake packet, or a QUIC 1-RTT packet.

Sending device 450 may then predict a burst size (BSSize) value for a current data burst of a communication session with the receiving device (500). For example, sending device 450 may determine that protocol data units (PDUs) of a PDU Set to be sent in the current data burst are to be sent via Real-time Transport Protocol (RTP). Thus, sending device 450 may signal data representing the predicted BSSize value with an ordinal first PDU of the data burst (502), e.g., in an RTP header extension that encapsulates the ordinal first PDU of the data burst, such as discussed above with respect to FIGS. 5, 6, or 8 above. The RTP header extension may also include data representing a time to next burst, which may be signaled relative to a time at which an ordinal last PDU of the PDU Set of the current data burst as discussed above. Alternatively, sending device 450 may encapsulate the ordinal first PDU with a QUIC header extension including the predicted BSSize value (and possibly also the time to next burst value). Sending device 450 may then send the ordinal first PDU to the receiving device (504).

As noted above, the ordinal first PDU may be sent before all PDUs of the PDU Set of the current data burst have been fully formed. Therefore, sending device 450 may proceed to construct one or more additional PDUs of the PDU Set of the current data burst (506). In the process of constructing the one or more additional PDUs, sending device 450 may determine that the predicted BSSize value for the current data burst is not accurate, e.g., because additional data needs to be sent as part of the current data burst. Therefore, sending device 450 may determine an updated BSSize for the current data burst (508). Sending device 450 may further signal the updated (actual) BSSize value with a subsequent PDU of the current data burst (510). For example, sending device 450 may encapsulate the subsequent PDU with an RTP header extension or QUIC header extension indicating the updated BSSize value. The updated BSSize value may be signaled as a difference (delta) relative to the original predicted BSSize value or a most recently transmitted BSSize value, or may be signaled as an absolute size of all PDUs of the PDU Set of the current data burst. Sending device 450 may then proceed to send remaining PDUs of the PDU Set of the current data burst (512).

In this manner, the method of FIG. 11 represents an example of a method of communicating data via a network, including: predicting a predicted burst size (BSSize) for a data burst, the data burst including a plurality of protocol data units (PDUs); sending a first PDU of the data burst, the first PDU including data representing the predicted BSSize for the data burst, wherein sending the first PDU comprises sending the first PDU before an ordinal last PDU of the plurality of PDUs has been formed; after forming one or more additional PDUs of the plurality of PDUs, determining an actual BSSize value for the data burst; and sending a second PDU of the data burst, the second PDU including data for updating the predicted BSSize value for the data burst to the actual BSSize value for the data burst.

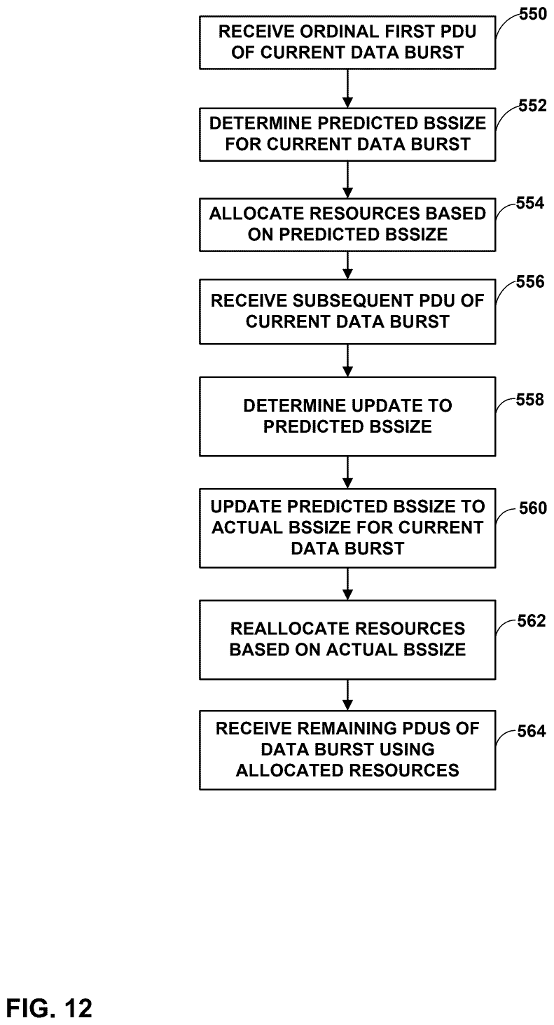

FIG. 12 is a flowchart illustrating an example method for receiving data of a communication session per techniques of this disclosure. The method of FIG. 12 may be performed by a receiving device, such as client device 40 of FIG. 1, UE device 458 of FIG. 10, or a base station, such as base station 456 of FIG. 10. For purposes of explanation and example, the method of FIG. 12 is discussed with respect to base station 456 of FIG. 10.

Initially, base station 456 may signal support for updates to current data burst size values, e.g., during a session negotiation for a communication session with a sending device, such as server device 60 of FIG. 1 or sending device 450 of FIG. 10. For example, base station 456 may send a session description protocol (SDP) message to sending device 450 indicating whether base station 456 supports BSSize value updates per these techniques. As another example, base station 456 may send a transport parameter indicating support for data burst size updates for the data bursts of the communication session, e.g., in one or more of a QUIC Initial packet, a QUIC handshake packet, or a QUIC 1-RTT packet.

During the communication session, base station 456 may receive an ordinal first PDU of a PDU Set of a current data burst (550). The ordinal first PDU may be encapsulated with an RTP header extension, QUIC header extension, or the like, including data representing a predicted burst size (BSSize) value for the current data burst. Alternatively, as discussed with respect to FIG. 10, an RTP packet or QUIC packet may further be encapsulated by a tunnel header, such as a GTP-U tunnel header, which may include the BSSize value. Thus, base station 456 may determine the predicted BSSize for the current data burst (552), e.g., from the RTP header extension, QUIC header extension, tunnel header, or the like.

Base station 456 may then allocate resources to receive subsequent data of the current data burst according to the predicted BSSize value (554). For example, base station 456 may perform frequency domain and/or temporal domain resource assignments, determine a modulation scheme, determine a coding scheme, allocate slots/symbols, allocate resource blocks/resource block groups, configure subcarrier spacing, and/or configure bandwidth parts (BWPs) to receive PDUs of the PDU Set of the current data burst based on the predicted BSSize value. Additionally or alternatively, base station 456 may configure UE device 458 using the predicted BSSize value, e.g., to disable reception circuitry during a time between receiving all data of the current data burst until a time of the next data burst, which may conserve battery power and/or processing power of UE device 458. Base station 456 may forward the ordinal first PDU to UE device 458.

Base station 456 may also receive a subsequent PDU of the PDU Set of the current data burst (556). Per techniques of this disclosure, the subsequent PDU may include an update to the predicted BSSize value, e.g., in an RTP extension header, QUIC extension header, tunnel header, or the like. The update may indicate a difference (delta) to be applied to the predicted BSSize value, a replacement BSSize value, or the like. Thus, base station 456 may determine the actual BSSize value for the current data burst using the update data. Base station 456 may then update the predicted BSSize value to the actual BSSize value for the current data burst (560). Base station 456 may also forward the subsequent PDU to UE device 458.

Base station 456 may then reallocate resources based on the actual BSSize value (562). For example, base station 456 may perform frequency domain and/or temporal domain resource assignments, determine a modulation scheme, determine a coding scheme, allocate slots/symbols, allocate resource blocks/resource block groups, configure subcarrier spacing, and/or configure bandwidth parts (BWPs) to receive PDUs of the PDU Set of the current data burst based on the predicted BSSize value. Additionally or alternatively, base station 456 may reconfigure UE device 458 using the predicted BSSize value, e.g., to disable reception circuitry during a time between receiving all data of the current data burst (based on the updated, actual BSSize value) until a time of the next data burst, which may conserve battery power and/or processing power of UE device 458, while also allowing UE device 458 to receive all data of the current data burst.

Base station 456 may then receive remaining PDUs of the current data burst using the reallocated resources (564) and send the remaining PDUs to UE device 458.

In this manner, the method of FIG. 12 represents an example of a method of communicating data via a network, including: receiving a first protocol data unit (PDU) of a data burst, the first PDU including data representing a predicted burst size (BSSize) value for the data burst; receiving a second PDU of the data burst after having received the first PDU, the second PDU including data for updating the predicted BSSize value for the data burst to an actual BSSize value for the data burst; updating the predicted BSSize value to the actual BSSize value based on the data of the second PDU; and using the actual BSSize value to receive one or more subsequent PDUs of the data burst.

Various examples of the techniques of this disclosure are summarized in the clauses below:

Clause 1: A method of communicating media data, the method comprising communicating a Real-time Transport Protocol (RTP) header extension including data representing a time to next data burst (TNDB) value and data representing whether the TNDB value is relative to an ordinal first protocol data unit (PDU) of a current data burst or to an ordinal last PDU of the current data burst.

Clause 2: The method of clause 1, wherein the RTP header extension comprises an RTP header extension for PDU Set marking.

Clause 3: The method of clause 2, wherein the RTP header extension for PDU Set marking has a one-byte format.

Clause 4: The method of clause 2, wherein the RTP header extension for PDU Set marking has a two-byte format.

Clause 5: The method of any of clauses 2-4, wherein the RTP header extension for PDU Set marking includes a two-bit value comprising the data representing whether the TNDB value is relative to the ordinal first PDU of the current data burst or to the ordinal last PDU of the current data burst.

Clause 6: The method of clause 5, wherein the two-bit value comprises a value of 10 to indicate that the TNDB value is relative to the ordinal first PDU of the current data burst or a value of 01 to indicate that the TNDB value is relative to the ordinal last PDU of the current data burst.

Clause 7: The method of clause 1, wherein the RTP header extension comprises an RTP header extension for data burst traffic characteristics.

Clause 8: The method of clause 7, wherein the RTP header extension for data burst traffic characteristics has a one-byte format.

Clause 9: The method of clause 7, wherein the RTP header extension for data burst traffic characteristics has a two-byte format.

Clause 10: The method of any of clauses 7-9, wherein the RTP header extension for data burst traffic characteristics includes a one-bit value comprising the data representing whether the TNDB value is relative to the ordinal first PDU of the current data burst or to the ordinal last PDU of the current data burst.

Clause 11: The method of clause 10, wherein the one-bit value comprises a value of 1 to indicate that the TNDB value is relative to the ordinal first PDU of the current data burst or a value of 0 to indicate that the TNDB value is relative to the ordinal last PDU of the current data burst.

Clause 12: The method of any of clauses 1-11, further comprising communicating data representing accuracy of the TNDB value.

Clause 13: The method of clause 12, wherein the data representing the accuracy of the TNDB value includes an integer component and a fractional component.

Clause 14: The method of any of clauses 12 and 13, wherein the data representing the accuracy of the TNDB value represents one of a jitter, a standard deviation, or a confidence interval.

Clause 15: The method of any of clauses 12-14, wherein the data representing the accuracy of the TNDB value comprises a value of y indicating +/−y units of time, such that the TNDB value of x with accuracy y indicates that the TNDB is in the range [x−y, x+y].

Clause 16: The method of any of clauses 12-15, wherein communicating the data representing the accuracy of the TNDB value comprises communicating the data representing the accuracy of the TNDB value in an RTP header extension.

Clause 17: The method of clause 16, wherein the RTP header extension comprises an RTP header extension for PDU Set marking.

Clause 18: The method of clause 16, wherein the RTP header extension comprises an RTP header extension for data burst traffic characteristics.

Clause 19: The method of any of clauses 1-18, further comprising communicating data representing an accuracy of a size of the next data burst (SNDB) value.

Clause 20: The method of clause 19, wherein the data representing the accuracy of the SNDB value represents one of a jitter, a standard deviation, or a confidence interval.

Clause 21: The method of any of clauses 19 and 20, wherein the data representing the accuracy of the SNDB value x represents an absolute error value y, such that the SNDB is in the range [x−y, x+y].

Clause 22: The method of any of clauses 19 and 20, wherein the data representing the accuracy of the SNDB value x represents a relative error value a, such that the SNDB is in the range [x(1−a), x(1+a)].

Clause 23: The method of any of clauses 19-22, wherein communicating the data representing the accuracy of the SNDB value comprises communicating the data representing the accuracy of the TNDB value in an RTP header extension.

Clause 24: The method of clause 23, wherein the RTP header extension comprises an RTP header extension for PDU Set marking.

Clause 25: The method of clause 23, wherein the RTP header extension comprises an RTP header extension for data burst traffic characteristics.

Clause 26: The method of any of clauses 1-25, wherein the TNDB value comprises a burst size update for the current data burst.

Clause 27: The method of clause 26, wherein communicating the RTP header extension comprises communicating a PDU of the current data burst including the RTP header extension after having communicated an ordinal first PDU of the current data burst including an RTP header extension including a first TNDB value for the current data burst.

Clause 28: The method of any of clauses 26 and 27, wherein the burst size update represents a remaining amount of data for the current data burst.

Clause 29: The method of any of clauses 26 and 27, wherein the burst size update represents a total amount of data for the current data burst including data for one or more previous PDUs of the current data burst.

Clause 30: The method of any of clauses 26-29, wherein the RTP header extension further includes data indicating that the TNDB value represents an update to a previously communicated TNDB value for the current data burst.

Clause 31: The method of any of clauses 26-30, further comprising communicating negotiation data representing support for burst size updates for data bursts during session establishment for a communication session.

Clause 32: The method of clause 31, wherein communicating the negotiation data comprises communicating session description protocol (SDP) data.

Clause 33: The method of clause 32, wherein the SDP data conforms to an augmented Backus-Naur format of: extensionname=“urn:3gpp:sa4:5grtp:dynamic-traffic-characteristics-rel19”; extensionattributes=[format SP][BSSize-update].

Clause 34: The method of clause 31, wherein communicating the negotiation data comprises communicating a transport parameter representing a unilateral declaration of support for burst size updates.

Clause 35: The method of any of clauses 1-34, wherein communicating comprises sending.

Clause 36: The method of any of clauses 1-34, wherein communicating comprises receiving.

Clause 37: The method of clause 36, wherein receiving comprises receiving by a base station, the method further comprising allocating resources based on the TNDB value.

Clause 38: A method of communicating media data, the method comprising: sending an ordinal first protocol data unit (PDU) of a current data burst of a media communication session, the ordinal first PDU including data representing a burst size for the current data burst; and after sending the ordinal first PDU of the current data burst, sending a second PDU of the current data burst, the second PDU including data representing a burst size update for the current data burst.

Clause 39: A method of communicating media data, the method comprising: receiving an ordinal first protocol data unit (PDU) of a current data burst of a media communication session, the ordinal first PDU including data representing a burst size for the current data burst; allocating resources for receiving remaining PDUs of the current data burst according to the burst size; after receiving the ordinal first PDU of the current data burst, receiving a second PDU of the current data burst, the second PDU including data representing a burst size update for the current data burst; and reallocating resources for receiving the remaining PDUs of the current data burst according to the burst size update.

Clause 40: The method of any of clauses 38 and 39, wherein the data representing the burst size update is included in a real-time transport protocol (RTP) header extension of an RTP header encapsulating the second PDU.

Clause 41: The method of clause 40, further comprising communicating negotiation data representing support for burst size updates for data bursts during session establishment for a communication session.

Clause 42: The method of clause 41, wherein communicating the negotiation data comprises communicating session description protocol (SDP) data.

Clause 43: The method of clause 42, wherein the SDP data conforms to an augmented Backus-Naur format of: extensionname=“urn:3gpp:sa4:5grtp:dynamic-traffic-characteristics-rel19”; extensionattributes=[format SP][BSSize-update].

Clause 44: The method of any of clauses 38 and 39, wherein the data representing the burst size update is included in a QUIC header encapsulating the second PDU.

Clause 45: The method of clause 44, further comprising communicating negotiation data representing support for burst size updates for data bursts during session establishment for a communication session.

Clause 46: The method of clause 45, wherein communicating the negotiation data comprises communicating the negotiation data in one or more of a QUIC Initial packet, a QUIC handshake packet, or a QUIC 1-RTT packet.

Clause 47: The method of any of clauses 45 and 46, wherein the negotiation data comprises a transport parameter indicating support for data burst size updates for data bursts.

Clause 48: A device for retrieving media data, the device comprising one or more means for performing the method of any of clauses 1-47.

Clause 49: The device of clause 48, wherein the one or more means comprise a memory and a processing system implemented in circuitry.

Clause 50: The device of clause 48, wherein the device comprises at least one of: an integrated circuit; a microprocessor; or a wireless communication device.

Clause 51: A device for communicating media data, the device comprising means for communicating a Real-time Transport Protocol (RTP) header extension including data representing a time to next data burst (TNDB) value and data representing whether the TNDB value is relative to an ordinal first protocol data unit (PDU) of a current data burst or to an ordinal last PDU of the current data burst.

Clause 52: A device for communicating media data, the device comprising: means for sending an ordinal first protocol data unit (PDU) of a current data burst of a media communication session, the ordinal first PDU including data representing a burst size for the current data burst; and means for sending, after sending the ordinal first PDU of the current data burst, a second PDU of the current data burst, the second PDU including data representing a burst size update for the current data burst.

Clause 53: A device for communicating media data, the device comprising: means for receiving an ordinal first protocol data unit (PDU) of a current data burst of a media communication session, the ordinal first PDU including data representing a burst size for the current data burst; means for allocating resources for receiving remaining PDUs of the current data burst according to the burst size; means for receiving, after receiving the ordinal first PDU of the current data burst, a second PDU of the current data burst, the second PDU including data representing a burst size update for the current data burst; and means for reallocating resources for receiving the remaining PDUs of the current data burst according to the burst size update.

Clause 54: The device of clause 53, wherein the device comprises a base station of a radio access network (RAN).

Clause 55: A method of communicating data via a network, the method comprising: receiving a first protocol data unit (PDU) of a data burst, the first PDU including data representing a predicted burst size (BSSize) value for the data burst; receiving a second PDU after having received the first PDU, the second PDU including data for updating the predicted BSSize value for the data burst to an actual BSSize value for the data burst; updating the predicted BSSize value to the actual BSSize value based on the data of the second PDU; and using the actual BSSize value to receive one or more subsequent PDUs of the data burst.

Clause 56: The method of clause 55, wherein the data for updating the predicted BSSize value is included in a real-time transport protocol (RTP) header extension of an RTP header encapsulating the second PDU.

Clause 57: The method of clause 56, further comprising sending data representing support for burst size updates for data bursts during session establishment for a communication session including the data burst.

Clause 58: The method of clause 57, wherein sending the data representing the support for burst size updates comprises sending session description protocol (SDP) data.

Clause 59: The method of clause 58, wherein the SDP data conforms to an augmented Backus-Naur format of: extensionname=“urn:3gpp:sa4:5grtp:dynamic-traffic-characteristics-rel19”; extensionattributes=[format SP][BSSize-update].

Clause 60: The method of clause 55, wherein the data for updating the predicted BSSize value is included in a QUIC header encapsulating the second PDU.

Clause 61: The method of clause 60, further comprising sending data representing support for burst size updates for data bursts during session establishment for a communication session including the data burst.

Clause 62: The method of clause 61, wherein sending the data representing the support for burst size updates comprises sending the data in one or more of a QUIC Initial packet, a QUIC handshake packet, or a QUIC 1-RTT packet.

Clause 63: The method of clause 61, wherein sending the data representing the support for burst size updates comprises sending a transport parameter indicating the support for data burst size updates for the data bursts of the communication session.

Clause 64: The method of clause 55, wherein using the actual BSSize value to receive the one or more subsequent PDUs of the data burst comprises: in response to the predicted BSSize value, performing a first resource allocation based on the predicted BSSize value to allocate first resources to receive data having a first size corresponding to the predicted BSSize value; and in response to updating the predicted BSSize value to the actual BSSize value, performing a second resource allocation based on the actual BSSize value to allocate second resources to receive data having a second size corresponding to the actual BSSize value.

Clause 65: The method of clause 55, wherein using the actual BSSize value to receive the one or more subsequent PDUs of the data burst comprises: in response to the predicted BSSize value, scheduling reception circuitry to stop receiving data after having received a first amount of data corresponding to the predicted BSSize value; and in response to the actual BSSize value, rescheduling the reception circuitry to stop receiving data after having received a second amount of data corresponding to the actual BSSize value.

Clause 66: The method of clause 55, wherein the data for updating the predicted BSSize value comprises a size of remaining PDUs of the data burst, and wherein updating the predicted BSSize value comprises adding the size of the remaining PDUs to the predicted BSSize value to form the actual BSSize value.

Clause 67: The method of clause 55, wherein the data for updating the predicted BSSize value comprises a size of all PDUs of the data burst, and wherein updating the predicted BSSize value comprises replacing the predicted BSSize value with the size of all PDUs of the data burst to form the actual BSSize value.

Clause 68: The method of clause 55, further comprising receiving a Real-time Transport Protocol (RTP) header extension including data representing a time to next data burst (TNDB) value relative to an ordinal last PDU of the data burst.

Clause 69: The method of clause 68, wherein the RTP header extension comprises an RTP header extension for PDU Set marking.

Clause 70: The method of clause 69, wherein the RTP header extension for PDU Set marking has a one-byte format.

Clause 71: The method of clause 69, wherein the RTP header extension for PDU Set marking has a two-byte format.

Clause 72: The method of any of clauses 69-71, wherein the RTP header extension for PDU Set marking includes a two-bit value comprising the data representing whether the TNDB value is relative to the ordinal first PDU of the current data burst or to the ordinal last PDU of the current data burst.

Clause 73: The method of clause 72, wherein the two-bit value comprises a value of 10 to indicate that the TNDB value is relative to the ordinal first PDU of the current data burst or a value of 01 to indicate that the TNDB value is relative to the ordinal last PDU of the current data burst.

Clause 74: The method of clause 68, wherein the RTP header extension comprises an RTP header extension for data burst traffic characteristics.

Clause 75: The method of clause 74, wherein the RTP header extension for data burst traffic characteristics has a one-byte format.

Clause 76: The method of clause 74, wherein the RTP header extension for data burst traffic characteristics has a two-byte format.

Clause 77: The method of any of clauses 74-76, wherein the RTP header extension for data burst traffic characteristics includes a one-bit value comprising the data representing whether the TNDB value is relative to the ordinal first PDU of the current data burst or to the ordinal last PDU of the current data burst.

Clause 78: The method of clause 77, wherein the one-bit value comprises a value of 1 to indicate that the TNDB value is relative to the ordinal first PDU of the current data burst or a value of 0 to indicate that the TNDB value is relative to the ordinal last PDU of the current data burst.

Clause 79: The method of any of clauses 1-78, further comprising communicating data representing accuracy of the TNDB value.

Clause 80: The method of clause 79, wherein the data representing the accuracy of the TNDB value includes an integer component and a fractional component.

Clause 81: The method of any of clauses 79 and 80, wherein the data representing the accuracy of the TNDB value represents one of a jitter, a standard deviation, or a confidence interval.

Clause 82: The method of any of clauses 79-81, wherein the data representing the accuracy of the TNDB value comprises a value of y indicating +/−y units of time, such that the TNDB value of x with accuracy y indicates that the TNDB is in the range [x−y, x+y].

Clause 83: The method of any of clauses 79-82, wherein communicating the data representing the accuracy of the TNDB value comprises communicating the data representing the accuracy of the TNDB value in an RTP header extension.

Clause 84: The method of clause 83, wherein the RTP header extension comprises an RTP header extension for PDU Set marking.

Clause 85: The method of clause 83, wherein the RTP header extension comprises an RTP header extension for data burst traffic characteristics.

Clause 86: The method of any of clauses 1-85, further comprising communicating data representing an accuracy of a size of the next data burst (SNDB) value.

Clause 87: The method of clause 86, wherein the data representing the accuracy of the SNDB value represents one of a jitter, a standard deviation, or a confidence interval.

Clause 88: The method of any of clauses 86 and 87, wherein the data representing the accuracy of the SNDB value x represents an absolute error value y, such that the SNDB is in the range [x−y, x+y].

Clause 89: The method of any of clauses 86 and 87, wherein the data representing the accuracy of the SNDB value x represents a relative error value a, such that the SNDB is in the range [x(1−a), x(1+a)].

Clause 90: The method of any of clauses 86-89, wherein communicating the data representing the accuracy of the SNDB value comprises communicating the data representing the accuracy of the TNDB value in an RTP header extension.

Clause 91: The method of clause 90, wherein the RTP header extension comprises an RTP header extension for PDU Set marking.

Clause 92: The method of clause 90, wherein the RTP header extension comprises an RTP header extension for data burst traffic characteristics.

Clause 93: A device for communicating data via a network, the device comprising: a memory configured to store data; and a processing system implemented in circuitry and configured to: receive a first protocol data unit (PDU) of a data burst, the first PDU including data representing a predicted burst size (BSSize) value for the data burst; receive a second PDU after having received the first PDU, the second PDU including data for updating the predicted BSSize value for the data burst to an actual BSSize value for the data burst; update the predicted BSSize value to the actual BSSize value based on the data of the second PDU; and use the actual BSSize value to receive one or more subsequent PDUs of the data burst.

Clause 94: The device of clause 93, wherein the data for updating the predicted BSSize value is included in a real-time transport protocol (RTP) header extension of an RTP header encapsulating the second PDU.

Clause 95: The device of clause 94, wherein the processing system is further configured to send data representing support for burst size updates for data bursts during session establishment for a communication session including the data burst.

Clause 96: The device of clause 95, wherein to send the data representing the support for burst size updates, the processing system is configured to send session description protocol (SDP) data.

Clause 97: The method of clause 96, wherein the SDP data conforms to an augmented Backus-Naur format of: extensionname=“urn:3gpp:sa4:5grtp:dynamic-traffic-characteristics-rel19”; extensionattributes=[format SP][BSSize-update].

Clause 98: The device of clause 93, wherein the data for updating the predicted BSSize value is included in a QUIC header encapsulating the second PDU.

Clause 99: The device of clause 98, wherein the processing system is further configured to send data representing support for burst size updates for data bursts during session establishment for a communication session including the data burst.

Clause 100: The device of clause 99, wherein to send the data representing the support for burst size updates, the processing system is configured to send the data in one or more of a QUIC Initial packet, a QUIC handshake packet, or a QUIC 1-RTT packet.

Clause 101: The device of clause 99, wherein to send the data representing the support for burst size updates, the processing system is configured to send a transport parameter indicating the support for data burst size updates for the data bursts of the communication session.

Clause 102: The device of clause 93, wherein to use the actual BSSize value to receive the one or more subsequent PDUs of the data burst, the processing system is configured to: in response to the predicted BSSize value, perform a first resource allocation based on the predicted BSSize value to allocate first resources to receive data having a first size corresponding to the predicted BSSize value; and in response to updating the predicted BSSize value to the actual BSSize value, perform a second resource allocation based on the actual BSSize value to allocate second resources to receive data having a second size corresponding to the actual BSSize value.

Clause 103: The device of clause 93, wherein to use the actual BSSize value to receive the one or more subsequent PDUs of the data burst, the processing system is configured to: in response to the predicted BSSize value, schedule reception circuitry to stop receiving data after having received a first amount of data corresponding to the predicted BSSize value; and in response to the actual BSSize value, reschedule the reception circuitry to stop receiving data after having received a second amount of data corresponding to the actual BSSize value.

Clause 104: The device of clause 93, wherein the data for updating the predicted BSSize value comprises a size of remaining PDUs of the data burst, and wherein to update the predicted BSSize value, the processing system is configured to add the size of the remaining PDUs to the predicted BSSize value to form the actual BSSize value.

Clause 105: The device of clause 93, wherein the data for updating the predicted BSSize value comprises a size of all PDUs of the data burst, and wherein to update the predicted BSSize value, the processing system is configured to replace the predicted BSSize value with the size of all PDUs of the data burst to form the actual BSSize value.

Clause 106: The device of clause 93, wherein the processing system is further configured to receive a Real-time Transport Protocol (RTP) header extension including data representing a time to next data burst (TNDB) value relative to an ordinal last PDU of the data burst.

Clause 107: A method of communicating data via a network, the method comprising: predicting a predicted burst size (BSSize) for a data burst, the data burst including a plurality of protocol data units (PDUs); sending a first PDU of the data burst, the first PDU including data representing the predicted BSSize for the data burst, wherein sending the first PDU comprises sending the first PDU before an ordinal last PDU of the plurality of PDUs has been formed; after forming one or more additional PDUs of the plurality of PDUs, determining an actual BSSize value for the data burst; and sending a second PDU of the data burst, the second PDU including data for updating the predicted BSSize value for the data burst to the actual BSSize value for the data burst.

Clause 108: The method of clause 107, wherein the data for updating the predicted BSSize value is included in a real-time transport protocol (RTP) header extension of an RTP header encapsulating the second PDU.

Clause 109: The method of clause 108, further comprising receiving data representing support for burst size updates for data bursts during session establishment for a communication session including the data burst.

Clause 110: The method of clause 109, wherein receiving the data representing the support for burst size updates comprises receiving session description protocol (SDP) data.

Clause 111: The method of clause 110, wherein the SDP data conforms to an augmented Backus-Naur format of: extensionname=“urn:3gpp:sa4:5grtp:dynamic-traffic-characteristics-rel19”; extensionattributes=[format SP][BSSize-update].

Clause 112: The method of clause 107, wherein the data for updating the predicted BSSize value is included in a QUIC header encapsulating the second PDU.

Clause 113: The method of clause 112, further comprising receiving data representing support for burst size updates for data bursts during session establishment for a communication session including the data burst.

Clause 114: The method of clause 113, wherein receiving the data representing the support for burst size updates comprises receiving the data in one or more of a QUIC Initial packet, a QUIC handshake packet, or a QUIC 1-RTT packet.

Clause 115: The method of clause 113, wherein receiving the data representing the support for burst size updates comprises receiving a transport parameter indicating the support for data burst size updates for the data bursts of the communication session.

Clause 116: The method of clause 107, wherein the data for updating the predicted BSSize value comprises a size of remaining PDUs of the data burst.

Clause 117: The method of clause 107, wherein the data for updating the predicted BSSize value comprises a size of all PDUs of the data burst.

Clause 118: The method of clause 107, further comprising sending a Real-time Transport Protocol (RTP) header extension including data representing a time to next data burst (TNDB) value relative to the ordinal last PDU of the data burst.

Clause 119: A device for communicating data via a network, the device comprising: a memory configured to store data; and a processing system implemented in circuitry and configured to: predict a predicted burst size (BSSize) for a data burst, the data burst including a plurality of protocol data units (PDUs); send a first PDU of the data burst, the first PDU including data representing the predicted BSSize for the data burst, wherein sending the first PDU comprises sending the first PDU before an ordinal last PDU of the plurality of PDUs has been formed; after forming one or more additional PDUs of the plurality of PDUs, determine an actual BSSize value for the data burst; and send a second PDU of the data burst, the second PDU including data for updating the predicted BSSize value for the data burst to the actual BSSize value for the data burst.

Clause 120: The device of clause 119, wherein the data for updating the predicted BSSize value is included in a real-time transport protocol (RTP) header extension of an RTP header encapsulating the second PDU.

Clause 121: The device of clause 120, wherein the processing system is further configured to receive data representing support for burst size updates for data bursts during session establishment for a communication session including the data burst.

Clause 122: The device of clause 121, wherein to receive the data representing the support for burst size updates, the processing system is configured to receive session description protocol (SDP) data.

Clause 123: The device of clause 122, wherein the SDP data conforms to an augmented Backus-Naur format of: extensionname=“urn:3gpp:sa4:5grtp:dynamic-traffic-characteristics-rel19”; extensionattributes=[format SP][BSSize-update].

Clause 124: The device of clause 119, wherein the data for updating the predicted BSSize value is included in a QUIC header encapsulating the second PDU.

Clause 125: The device of clause 124, wherein the processing system is further configured to receive data representing support for burst size updates for data bursts during session establishment for a communication session including the data burst.

Clause 126: The device of clause 125, wherein to receive the data representing the support for burst size updates, the processing system is configured to receive the data in one or more of a QUIC Initial packet, a QUIC handshake packet, or a QUIC 1-RTT packet.

Clause 127: The device of clause 125, wherein to receive the data representing the support for burst size updates, the processing system is configured to receive a transport parameter indicating the support for data burst size updates for the data bursts of the communication session.

Clause 128: The device of clause 119, wherein the data for updating the predicted BSSize value comprises a size of remaining PDUs of the data burst.

Clause 129: The device of clause 119, wherein the data for updating the predicted BSSize value comprises a size of all PDUs of the data burst.

Clause 130: The device of clause 119, wherein the processing system is further configured to send a Real-time Transport Protocol (RTP) header extension including data representing a time to next data burst (TNDB) value relative to the ordinal last PDU of the data burst.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of communicating data via a network, the method comprising:
receiving a first protocol data unit (PDU) of a data burst, the first PDU including data representing a predicted burst size (BSSize) value for the data burst;
receiving a second PDU of the data burst after having received the first PDU, the second PDU including data for updating the predicted BSSize value for the data burst to an actual BSSize value for the data burst;
updating the predicted BSSize value to the actual BSSize value based on the data of the second PDU; and
using the actual BSSize value to receive one or more subsequent PDUs of the data burst.

2. The method of claim 1, wherein the data for updating the predicted BSSize value is included in a real-time transport protocol (RTP) header extension of an RTP header encapsulating the second PDU.

3. The method of claim 2, further comprising sending data representing support for burst size updates for data bursts during session establishment for a communication session including the data burst.

4. The method of claim 3, wherein sending the data representing the support for burst size updates comprises sending session description protocol (SDP) data.

5. The method of claim 4, wherein the SDP data conforms to an augmented Backus-Naur format of:
extensionname=“urn:3gpp:sa4:5grtp: dynamic-traffic-characteristics-rel19”;
extensionattributes=[format SP][BSSize-update].

6. The method of claim 1, wherein the data for updating the predicted BSSize value is included in a QUIC header encapsulating the second PDU.

7. The method of claim 6, further comprising sending data representing support for burst size updates for data bursts during session establishment for a communication session including the data burst.

8. The method of claim 7, wherein sending the data representing the support for burst size updates comprises sending the data in one or more of a QUIC Initial packet, a QUIC handshake packet, or a QUIC 1-RTT packet.

9. The method of claim 7, wherein sending the data representing the support for burst size updates comprises sending a transport parameter indicating the support for data burst size updates for the data bursts of the communication session.

10. The method of claim 1, wherein using the actual BSSize value to receive the one or more subsequent PDUs of the data burst comprises:
in response to the predicted BSSize value, performing a first resource allocation based on the predicted BSSize value to allocate first resources to receive data having a first size corresponding to the predicted BSSize value; and
in response to updating the predicted BSSize value to the actual BSSize value, performing a second resource allocation based on the actual BSSize value to allocate second resources to receive data having a second size corresponding to the actual BSSize value.

11. The method of claim 1, wherein using the actual BSSize value to receive the one or more subsequent PDUs of the data burst comprises:
in response to the predicted BSSize value, scheduling reception circuitry to stop receiving data after having received a first amount of data corresponding to the predicted BSSize value; and
in response to the actual BSSize value, rescheduling the reception circuitry to stop receiving data after having received a second amount of data corresponding to the actual BSSize value.

12. The method of claim 1, wherein the data for updating the predicted BSSize value comprises a size of remaining PDUs of the data burst, and wherein updating the predicted BSSize value comprises adding the size of the remaining PDUs to the predicted BSSize value to form the actual BSSize value.

13. The method of claim 1, wherein the data for updating the predicted BSSize value comprises a size of all PDUs of the data burst, and wherein updating the predicted BSSize value comprises replacing the predicted BSSize value with the size of all PDUs of the data burst to form the actual BSSize value.

14. The method of claim 1, further comprising receiving a Real-time Transport Protocol (RTP) header extension including data representing a time to next data burst (TNDB) value relative to an ordinal last PDU of the data burst.

15. A device for communicating data via a network, the device comprising:
a memory configured to store data; and
a processing system implemented in circuitry and configured to:
receive a first protocol data unit (PDU) of a data burst, the first PDU including data representing a predicted burst size (BSSize) value for the data burst;
receive a second PDU after having received the first PDU, the second PDU including data for updating the predicted BSSize value for the data burst to an actual BSSize value for the data burst;
update the predicted BSSize value to the actual BSSize value based on the data of the second PDU; and
use the actual BSSize value to receive one or more subsequent PDUs of the data burst.

16. The device of claim 15, wherein the data for updating the predicted BSSize value is included in a real-time transport protocol (RTP) header extension of an RTP header encapsulating the second PDU.

17. The device of claim 15, wherein the data for updating the predicted BSSize value is included in a QUIC header encapsulating the second PDU.

18. A method of communicating data via a network, the method comprising:
predicting a predicted burst size (BSSize) for a data burst, the data burst including a plurality of protocol data units (PDUs);
sending a first PDU of the data burst, the first PDU including data representing the predicted BSSize for the data burst, wherein sending the first PDU comprises sending the first PDU before an ordinal last PDU of the plurality of PDUs has been formed;
after forming one or more additional PDUs of the plurality of PDUs, determining an actual BSSize value for the data burst; and
sending a second PDU of the data burst, the second PDU including data for updating the predicted BSSize value for the data burst to the actual BSSize value for the data burst.

19. The method of claim 18, wherein the data for updating the predicted BSSize value is included in a real-time transport protocol (RTP) header extension of an RTP header encapsulating the second PDU.

20. The method of claim 19, further comprising receiving data representing support for burst size updates for data bursts during session establishment for a communication session including the data burst.

21. The method of claim 20, wherein receiving the data representing the support for burst size updates comprises receiving session description protocol (SDP) data.

22. The method of claim 21, wherein the SDP data conforms to an augmented Backus-Naur format of:
extensionname=“urn:3gpp:sa4:5grtp: dynamic-traffic-characteristics-rel19”;
extensionattributes=[format SP][BSSize-update].

23. The method of claim 18, wherein the data for updating the predicted BSSize value is included in a QUIC header encapsulating the second PDU.

24. The method of claim 23, further comprising receiving data representing support for burst size updates for data bursts during session establishment for a communication session including the data burst.

25. The method of claim 24, wherein receiving the data representing the support for burst size updates comprises receiving the data in one or more of a QUIC Initial packet, a QUIC handshake packet, or a QUIC 1-RTT packet.

26. The method of claim 24, wherein receiving the data representing the support for burst size updates comprises receiving a transport parameter indicating the support for data burst size updates for the data bursts of the communication session.

27. The method of claim 18, wherein the data for updating the predicted BSSize value comprises a size of remaining PDUs of the data burst.

28. The method of claim 18, wherein the data for updating the predicted BSSize value comprises a size of all PDUs of the data burst.

29. The method of claim 18, further comprising sending a Real-time Transport Protocol (RTP) header extension including data representing a time to next data burst (TNDB) value relative to the ordinal last PDU of the data burst.

30. A device for communicating data via a network, the device comprising:
a memory configured to store data; and
a processing system implemented in circuitry and configured to:
predict a predicted burst size (BSSize) for a data burst, the data burst including a plurality of protocol data units (PDUs);
send a first PDU of the data burst, the first PDU including data representing the predicted BSSize for the data burst, wherein sending the first PDU comprises sending the first PDU before an ordinal last PDU of the plurality of PDUs has been formed;
after forming one or more additional PDUs of the plurality of PDUs, determine an actual BSSize value for the data burst; and
send a second PDU of the data burst, the second PDU including data for updating the predicted BSSize value for the data burst to the actual BSSize value for the data burst.
